(19) United States
(12) Patent Application Publication
(10) Pub. No.: US 2019/0369631 A1
(43) Pub. Date: Dec. 5, 2019

(54) INTELLIGENT WHEELCHAIR SYSTEM BASED ON BIG DATA AND ARTIFICIAL INTELLIGENCE

(71) Applicant: SICHUAN GOLDEN RIDGE INTELLIGENCE SCIENCE & TECHNOLOGY CO.,LTD., Chengdu, Sichuan (CN)

(72) Inventors: Yin JIAO, Gothenburg (SE); Jiaxin LI, Chengdu (CN); Weirong LIU, Beijing (CN); Li YAN, Gothenburg (SE); Dong DONG, Gothenburg (SE); Yifeng HUANG, Gothenburg (SE)

(73) Assignee: Sichuan Golden Ridge Intellgence Science & Technology Co., Ltd., Chengdu, Sichuan (CN)

(21) Appl. No.: 16/477,178

(22) PCT Filed: Jan. 22, 2017
(86) PCT No.: PCT/CN2017/072101

§ 371 Date: Jul. 10, 2019

(51) Int. Cl. G05D 1/02; G06T 7/70; G06T 7/55; G01C 21/34; A61G 5/04; G05B 13/02

(52) U.S. Cl. CPC G05D 1/0231; G06T 7/70; G06T 7/55; G06T 2207/30244; A61G 5/04; G05B 13/0265; G01C 21/34

(57) ABSTRACT

The present disclosure discloses an intelligent wheelchair system and method based on big data and artificial intelligence. The intelligent wheelchair system may include a processor (210), a movement module (920), and a holder (930). The processor (210) may be configured to implement operations such as receiving information, constructing a map, planning a route, and generating control parameters. The movement module (920) may execute the control parameters to move around and include sensors (1220) to sense information. The holder may include sensors (1240) to sense information.

### TECHNICAL FIELD

The present disclosure relates to an intelligent wheelchair system based on big data and artificial intelligence and a control method thereof, and specifically relates to a moving intelligent robot based on the big data and the artificial intelligence, and control methods for controlling image detection and processing, route exploring and robot movement.

### BACKGROUND

Intelligent devices capable of moving such as a cleaning robot and an intelligent balance wheel become more common in daily life. An intelligent robot system is able to recognize the surroundings and automatically move based on an existing map to provide services within an area where it is located. With rapidly expanded service demands, an intelligent robot system with multifunction of updating a map, planning a route and moving automatically is desired, and an intelligent robot adapted to a more complicated region is more expected.

In addition, with the acceleration of population aging in the society and the increasing number of lower limb injuries, providing superior travelling tools for the elderly and the disabled has become one of focuses of issues in the whole society. The lower limb injuries are caused by various diseases, work injuries, traffic accidents, etc. As a service robot, an intelligent wheelchair has various functions such as autonomous navigation, obstacle avoidance, man-machine dialog, providing special services, etc. The intelligent wheelchair may provide a safe and convenient lifestyle for disabled people with cognitive disorders (such as dementia patients, etc.), disabled people with mobility disorders (such as cerebral palsy patients, quadriplegia patients, etc.), the elderly, etc., thereby greatly improving the quality of their daily life and work, regaining their self-care ability and social integration. As an application platform for robot technology, the intelligent wheelchair combines various technologies from robot researches, e.g., robot navigation and positioning, machine vision, pattern recognition, multi-sensor information fusion, human-computer interaction, etc.

### SUMMARY

One aspect of the present disclosure relates to an intelligent wheelchair system. The intelligent wheelchair system may include a memory storing instructions and a processor in communication with the memory. When executing the instructions, the processor may be configured to establish communication with a movement module and a holder via a communication port. The processor may obtain information from sensors of the movement module and the holder to construct a map. The processor may further plan a route based on the information and determine control parameters based on the information.

Another aspect of the present disclosure relates to a method. The method may include establishing communication with a movement module and a holder via a communication port. The method may include obtaining information from sensors of the movement module and the holder to construct a map. The method may further include planning a route based on the information, and determining control parameters based on the information.

Yet another aspect of the present disclosure relates to a permanent computer readable medium embodied as a computer program product. The computer program product may include a communication port for establishing communication between a processor and a movement module, and between a processor and a holder. The communication port may establish communication by using an application program interface (API).

### BRIEF DESCRIPTION OF THE DRAWINGS

The methods, systems, and/or program described herein are further described in terms of embodiments. These exemplary embodiments are described in detail with reference to the drawings. These embodiments are non-limiting exemplary embodiments, in which like reference numerals represent similar structures throughout other views of the drawings, and wherein:

FIG. 1 is a schematic diagram illustrating an intelligent wheelchair system according to some embodiments of the present disclosure;

FIG. 2 is a block diagram illustrating a robot in the robot control system illustrated in FIG. 1 according to some embodiments of the present disclosure;

FIG. 3 is a block diagram illustrating a processor in the robot illustrated in FIG. 2 according to some embodiments of the present disclosure;

FIG. 4 is a block diagram illustrating an analysis module in the processor illustrated in FIG. 3 according to some embodiments of the present disclosure;

FIG. 5 is a block diagram illustrating a navigation module in a processor according to some embodiments of the present disclosure;

FIG. 6 is a schematic diagram illustrating a movement control according to some embodiments of the present disclosure;

FIG. 7 is a schematic diagram illustrating a movement control according to some embodiments of the present disclosure;

FIG. 8 is a schematic diagram illustrating an architecture of sensor(s) illustrated in FIG. 2 according to some embodiments of the present disclosure;

FIG. 9 is a schematic diagram illustrating a robot body illustrated in FIG. 2 according to some embodiments of the present disclosure;

FIG. 10 is a schematic diagram illustrating a movement module according to some embodiments of the present disclosure;

FIG. 11 is a schematic diagram illustrating an architecture of a holder illustrated in FIG. 9 according to some embodiments of the present disclosure;

FIG. 12 is a robot system according to some embodiments of the present disclosure;

FIG. 13 is a flowchart illustrating a process for determining control parameters to control a robot according to some embodiments of the present disclosure;

FIG. 14 is a flowchart illustrating a process for constructing a map according to some embodiments of the present disclosure;

FIG. 15 is a flowchart illustrating a process for determining one or more reference frames according to some embodiments of the present disclosure;

FIG. 16 is a flowchart illustrating a process for obtaining depth information, intensity information, and displacement information according to some embodiments of the present disclosure;

FIG. 17A is a flowchart illustrating a process for determining an initial displacement value according to some embodiments of the present disclosure;

FIG. 17B is a flowchart illustrating a process for determining an attitude of a robot according to some embodiments of the present disclosure;

FIG. 18 is a block diagram of a gyroscope and an accelerometer determining an angle between a horizontal plane and the Z axis according to some embodiments of the present disclosure;

FIG. 19 is a flowchart illustrating a process for determining an angle corresponding to a reference frame according to some embodiments of the present disclosure; and

FIG. 20 is a flowchart illustrating a process for adjusting vertical movement of a sensor in an intelligent device according to some embodiments of the present disclosure.

### DETAILED DESCRIPTION

In the following detailed description, numerous specific details are set forth by way of examples in order to provide a thorough understanding of the relevant disclosure. It should be apparent to those skilled in the art that the present disclosure may be practiced without such details. In other cases, well-known methods, procedures, systems, components, and/or circuits in the present disclosure have been described at relatively high levels elsewhere, and are not described in detail in this disclosure to avoid unnecessarily repeating.

It should be understood that the terms “system,” “apparatus,” “unit,” and/or “module” used in this disclosure are one method to distinguish different components, elements, parts, section or assembly of different level in ascending order. However, the terms may be displaced by other expression if they may achieve the same purpose.

It will be understood that when a device, unit, or module is referred to as being “on,” “connected to” or “coupled to” another device, unit, or module, it may be directly on, connected or coupled to, or communicate with the other device, unit, or module, or an intervening device, unit, or module may be present, unless the context clearly indicates otherwise. For example, as used herein, the term “and/or” includes any and all combinations of one or more of the associated listed items.

The terminology used herein is for the purpose of describing particular example embodiments only and is not intended to be limiting. As shown in the specification and claims of the present disclosure, words such as “a,” “an”, “one”, and/or “the” may be intended to include the plural forms as well, unless the context clearly indicates otherwise. In general, the terms “comprises,” “comprising,” “includes,” and/or “including” are merely meant to include the features, integers, steps, operations, elements and/or components that are specifically identified, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may be better understood upon consideration of the following description with reference to the accompanying drawing(s), all of which form a part of this specification. It is to be expressly understood, however, that the drawing(s) are for the purpose of illustration and description only and are not intended to limit the scope of the present disclosure. It should be understood that the drawings are not to scale.

Moreover, the system and method in the present disclosure is described primarily in regard to methods and systems for determining a state of an intelligent robot, it should also be understood that the description in this disclosure is only an exemplary embodiment. The intelligent robot system or method may also be applied to any type of intelligent devices or vehicles other than the intelligent robot. For example, the intelligent robot system or method may be applied to different intelligent device systems, and the intelligent device systems include a balance wheel, an unmanned ground vehicle (UGV), an intelligent wheelchair, or the like, or any combination thereof. The intelligent robot system may also be applied to any intelligent system for management and/or distribution, for example, a system for sending and/or receiving an express, carrying people or goods to some locations, etc.

The terms “robot,” “intelligent robot”, “intelligent device” in the present disclosure are used interchangeably to refer to an equipment, a device or a tool that may move and operate automatically. The term “user equipment” in the present disclosure may refer to a tool that may be used to request a service, order a service, or facilitate the providing of the service. The term “mobile terminal” in the present disclosure may refer to a tool or interface that may be used by a user to control the intelligent robot.

The positioning technology used in the present disclosure may include a global positioning system (GPS), a global navigation satellite system (GLONASS), a compass navigation system (COMPASS), a Galileo positioning system (Galileo), a quasi-zenith satellite system (QZSS), a wireless fidelity (WiFi) positioning technology, or the like, or any combination thereof. One or more of the above positioning technologies may be used interchangeably in the present disclosure.

The present disclosure describes an intelligent wheelchair system 100 as an exemplary system, and methods for constructing a map and planning a route for the intelligent wheelchair system 100. The method and system as disclosed herein may aim at constructing the map based on, e.g., information obtained by the intelligent wheelchair system 100. The information may be captured by sensor(s) located in the intelligent wheelchair system 100. Types of the sensor(s) may be optical or magnetic-electric. For example, the sensors may include a camera or a Lidar.

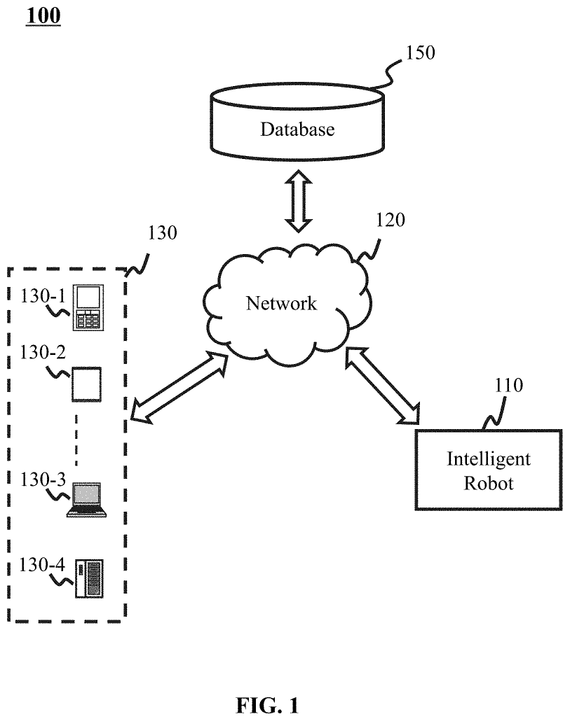

FIG. 1 is a schematic diagram illustrating an exemplary intelligent wheelchair system 100 according to some embodiments of the present disclosure. The intelligent wheelchair system 100 may include an intelligent robot 110, a network 120, a user device 130, and a database 140. A user may use the user device 130 to control the intelligent robot 110 via the network 120.

The intelligent robot 110 may establish communication with the user device 130. The communication between the intelligent robot 110 and the user device 130 may be wired or wireless. For example, the intelligent robot 110 may establish communication with the user device 130 or the database 140 via the network 120. The intelligent robot 110 may wirelessly control the intelligent robot 110 based on operational instructions (e.g., a movement instruction or a rotation instruction) from the user device 130. As another example, the intelligent robot 110 may be directly connected to the user device 130 or the database 140 via a cable or fiber. In some embodiments, the intelligent robot 110 may update or download a map stored in the database 140 based on the communication between the intelligent robot 110 and the database 140. For example, the intelligent robot 110 may capture information of routes and analyze the information to construct a map. In some embodiments, an entire map may be stored in the database 140. In some embodiments, the map constructed by the intelligent robot 110 may include information corresponding to a portion of the entire map. In some embodiments, the corresponding portion of the entire map may be updated by the constructed map. When a destination and a location of the intelligent robot 110 are determined, the entire map stored in the database 140 may be accessible to the intelligent robot 110. A portion of the entire map including the destination and the location of the intelligent robot 110 may be selected by the intelligent robot 110 to plan a route. In some embodiments, the intelligent robot 110 may plan the route based on the selected map, the destination and the location of the intelligent robot 110. In some embodiments, the intelligent robot 110 may use a map of the user device 130. For example, the user device 130 may download the map from the Internet. The user device 130 may instruct a movement of the intelligent robot 110 based on the map downloaded from the Internet. As another example, the user device 130 may download the latest map from the database 140. Once the destination and the location of the intelligent robot 110 are determined, the user device 130 may transmit the map obtained from the database 140 to intelligent robot 110. In some embodiments, the user device 130 may be a portion of the intelligent robot 110. In some embodiments, if the map constructed by the intelligent robot 110 includes the destination and the location, the intelligent robot 110 may plan the route based on the map.

The network 120 may include a single network or a combination of different networks. For example, the network 120 may include a local area network (LAN), a wide area network (WAN), a public network, a private network, a wireless local area network (WLAN), a virtual network, a metropolitan area network (MAN), a public switched telephone network (PSTN), or any combination thereof. For example, the intelligent robot 110 may communicate with the user device 130 and the database 140 via Bluetooth. The network 120 may also include various network access points. For example, a wired or wireless access point be included in the network 120. The wired or wireless access point may include a base station or an Internet exchange point. The user may send control operations from the user device 130 to the intelligent robot 110 and receive results via the network 120. The intelligent robot 110 may access information stored in the database 140 directly or via the network 120.

The user device 130 connectable to the network 120 may include a mobile device 130-1, a tablet computer 130-2, a laptop computer 130-3, a built-in device 130-4, or the like, or any combination thereof. In some embodiments, the mobile device 130-1 may include a wearable device, an intelligent mobile device, a virtual reality device, an augmented reality device, or the like, or any combination thereof. In some embodiments, the user may control the intelligent robot 110 using the wearable device. The wearable device may include an intelligent bracelet, an intelligent footwear, an intelligent glasses, an intelligent helmet, an intelligent watch, an intelligent clothing, an intelligent backpack, an intelligent accessory, or the like, or any combination thereof. In some embodiments, the intelligent mobile device may include a smart phone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality eyewear, or the like, or any combination thereof. For example, the virtual reality device and/or the augmented reality device may include a Google Glass™, an Oculus Rift™, a HoloLens™, a Gear VR™, or the like. In some embodiments, the built-in device 130-4 may include an onboard computer, an onboard television, or the like, or any combination thereof. In some embodiments, the user device 130 may include a device with positioning technology for positioning a location of the user and/or the user device 130 associated with the user. For example, a route may be determined by the intelligent robot 110 based on a map, a destination and a location of the intelligent robot 110. The location of the intelligent robot 110 may be obtained by the user device 130. In some embodiments, the user device 130 may be a device capable of capturing an image. For example, the map stored in the database 140 may be updated based on information captured by an image sensor (e.g., a camera). In some embodiments, the user device 130 may be a portion of the intelligent robot 110. For example, an intelligent phone with a camera, a gyroscope, and an accelerometer may be supported by a holder of the intelligent robot 110. The user device 130 may be used as a sensor to detect the information. As another example, a processor 210 and a storage 220 may be portions of the intelligent phone. In some embodiments, the user device 130 may also serve as a communication interface for the user of the intelligent robot 110. For example, the user may touch a screen of the user device 130 to select control operations of the intelligent robot 110.

The database 140 may store the entire map. In some embodiments, a plurality of intelligent robots wirelessly connected to the database 140 may exist. Each intelligent robot connected to the database 140 may construct a map based on information captured by a sensor of the intelligent robot. In some embodiments, the map constructed by the intelligent robot may be a portion of the entire map. During an updating process, the constructed map may replace a corresponding portion in the entire map. Each intelligent robot may download a map from the database 140 when a route from a location of the intelligent robot 110 to a destination needs to be planned. In some embodiments, the map downloaded from the database 140 may be a portion of the entire map at least including the location and the destination of the intelligent robot 110. The database 140 may also store historical information related to the user connected to the intelligent robot 110. For example, the historical information may include historical operations of the user or information related to how the intelligent robot 110 operates. As illustrated in FIG. 1, the database 140 may be accessed by the intelligent robot 110 and the user device 130.

It should be noted that the intelligent wheelchair system 100 described above is merely provided for illustrating an example of the system, and not intended to limit the scope of the present disclosure.

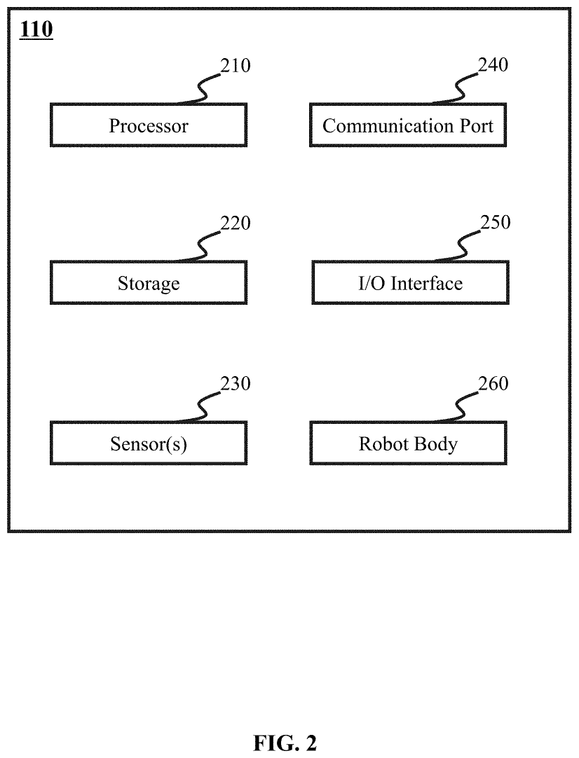

FIG. 2 is a block diagram illustrating an exemplary intelligent robot 110 in the intelligent wheelchair system 100 illustrated in FIG. 1 according to some embodiments of the present disclosure. The intelligent robot 110 may include a processor 210, a storage 220, sensor(s) 230, a communication port 240, an input/output interface 250, and a robot body 260. The sensor(s) 230 may obtain information. In some embodiments, the information may include image data, gyroscope data, accelerometer data, location data, and distance data. The processor 210 may process the information to generate one or more results. In some embodiments, the one or more results may include displacement information and depth information (e.g., a displacement of a camera between two adjacent frames, a depth of an object in two adjacent frames). In some embodiments, the processor 210 may construct a map based on the one or more results. The processor 210 may further transmit the map to the database 140 for updating. In some embodiments, the processor 210 may include one or more processors (e.g., a single-core processor or a multi-core processor). Mere by way of example, the processor 210 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The storage 220 may store instructions for the processor 210. When executing the instructions, the processor 210 may implement one or more functions or one or more operations described in the disclosure. For example, the storage 220 may store the instructions executed by the processor 210 to process the information obtained by the sensor(s) 230. In some embodiments, the processor 210 may automatically store the information obtained by the sensor(s) 230. The storage 220 may also store the one or more results (e.g., the displacement information and/or the depth information for constructing the map) generated by the processor 210. For example, the one or more results may be generated by the processor 210 and stored in the storage 220. The one or more results may be read by the processor 210 from the storage 220 to construct the map. In some embodiments, the storage 220 may store the map constructed by the processor 210. In some embodiments, the storage 220 may store a map obtained by the processor 210 from the database 140 or the user device 130. For example, the storage 220 may store the map constructed by the processor 210, and then the constructed map may be transmitted to the database 140 to update a corresponding portion of the entire map. As another example, the storage 220 may temporarily store the map downloaded by the processor 210 from the database 140 or the user device 130. In some embodiments, the storage 220 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), or a digital versatile disk ROM.

The sensor(s) 230 may be any device capable of obtaining the image data, the gyroscope data, the accelerometer data, the location data, the distance data from objects or obstacles, and any other data used by the intelligent robot 110 to implement various functions described in the present disclosure. For example, the sensor(s) 230 may include one or more night vision cameras for obtaining image data in low light environments. In some embodiments, the data and/or information obtained by the sensor(s) 230 may be stored in the storage 220 and processed by the processor 210. In some embodiments, the sensor(s) 230 may be installed in the robot body 260. More specifically, for example, one or more image sensors may be installed in a holder of the robot body 260. One or more navigation sensors, gyroscopes and accelerometers may be installed in both the holder and a movement module. In some embodiments, the sensor(s) 230 may automatically explore the environment and detect a location under the control of the processor 210. For example, the sensor(s) 230 may be used to dynamically sense or detect locations of objects, obstacles, or the like.

The communication port 240 may be a port for communication within the intelligent robot 110. That is, the communication port 240 may exchange information among components of the intelligent robot 110. In some embodiments, the communication port 240 may transmit signal/data of the processor 210 to an internal portion of the intelligent robot 110, and receive signals from the internal portion of the intelligent robot 110. For example, the processor 210 may receive information from the sensor(s) installed in the robot body 260. As another example, the processor 210 may transmit control operations to the robot body 260 via the communication port 240. The transmitting-receiving process may be implemented by the communication port 240. The communication port 240 may receive various wireless signals according to certain wireless communication specifications. In some embodiments, the communication port 240 may be provided as a communication module for known wireless local area communication such as a Wi-Fi, a Bluetooth, an infrared (IR), an ultra wideband (UWB), a ZigBee, or the like, or as a mobile communication module such as a 3G, a 4G or a Long Term Evolution (LTE), or as a known communication technique for wired communication. In some embodiments, the communication port 240 may be not limited to an element for transmitting/receiving signals from an internal device, and implemented as an interface for interactive communication. For example, the communication port 240 may establish communication between the processor 210 and other portions of the intelligent robot 110 by circuits using application programming interface (API). In some embodiments, the user device 130 may be a portion of the intelligent robot 110. In some embodiments, the communication between the processor 210 and the user device 130 may be implemented by the communication port 240.

The input/output interface 250 may be an interface for communication between the intelligent robot 110 and other external devices such as the database 140. In some embodiments, the input/output interface 250 may control data transmission with the intelligent robot 110. For example, the latest map may be transmitted from the database 140 to the intelligent robot 110. As another example, the map constructed based on the information obtained by the sensor(s) 230 may be transmitted from the database 140 to the intelligent robot 110. The input/output interface 250 may also include various additional elements such as a wireless communication module (not shown) for wireless communication or a tuner (not shown) for adjusting broadcast signals, which depends on a design type of the intelligent robot 110. The various communication elements may be used for receiving signals/data elements from external inputs. The input/output interface 250 may be provided as a communication module for known wireless local area communication, such as a Wi-Fi, a Bluetooth, an infrared (IR), a Ultra-Wide Band (UWB), a ZigBee, or the like, or as a mobile communication module such as a 3G, a 4G or a Long Term Evolution (LTE), or as a known input/output interface for wired communication. In some embodiments, the input/output interface 250 may be provided as a communication module for known wired communication such as fiber optics or Universal Serial Bus (USB). For example, the intelligent robot 110 may exchange data with the database 140 of a computer via a USB interface.

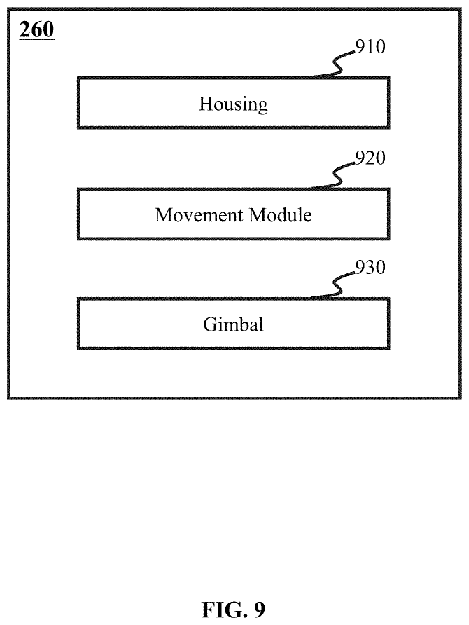

The robot body 260 may be a body for supporting the processor 210, the storage 220, the sensor(s) 230, the communication port 240, and the input/output interface 250. The robot body 260 may execute instructions from the processor 210 to move around, and to rotate the sensor(s) 230 to obtain or detect information of an area. In some embodiments, the robot body 260 may include a movement module and a holder as described in other portions of the disclosure (such as FIG. 9 and the description thereof) for the robot body 260. In some embodiments, the sensor(s) 230 may be installed in the movement module and the holder respectively.

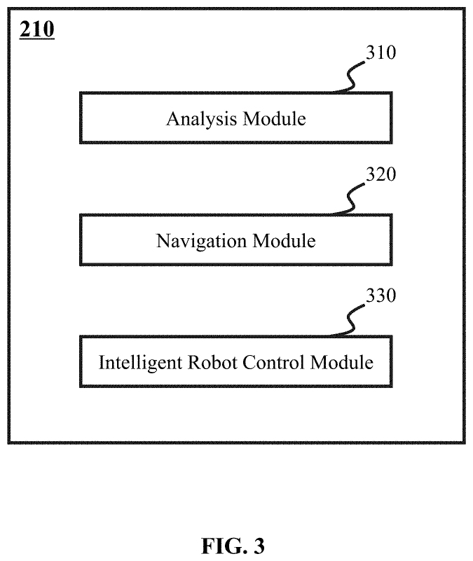

FIG. 3 is a block diagram illustrating an exemplary processor according to some embodiments of the present disclosure. As shown in FIG. 3, the processor 210 may include an analysis module 310, a navigation module 320, and an intelligent robot control module 330.

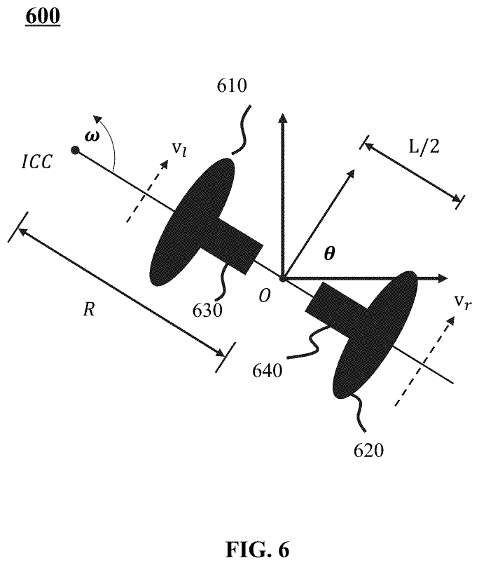

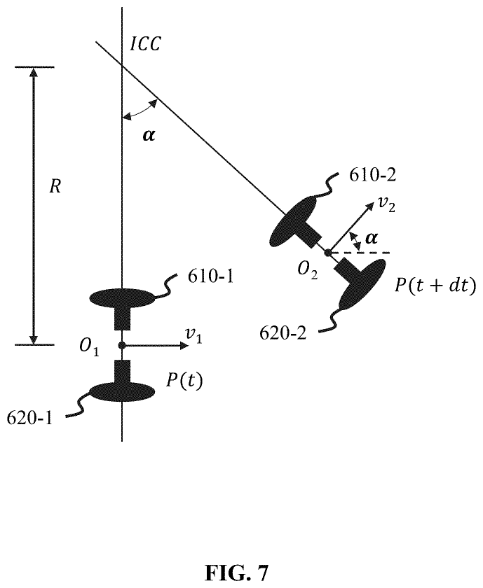

The analysis module 310 may analyze information obtained from the sensor(s) 230 and generate one or more results. The analysis module 310 may construct a map based on the one or more results. In some embodiments, the constructed map may be transmit to the database 140. In some embodiments, the analysis module 310 may receive the latest map from the database 140 and transmit the latest map to the navigation module 320. The navigation module 320 may plan a route from a location to a destination of the intelligent robot 110. In some embodiments, an entire map may be stored in the database 140. The map constructed by the analysis module 310 may correspond to a portion of the entire map. The updating process may include replacing the corresponding portion of the entire map with the constructed map. In some embodiments, the map constructed by the analysis module 310 may be latest and include the location and the destination of the intelligent robot 110. The analysis module 310 may be unnecessary to receive the map from the database 140. The map constructed by the analysis module 310 may be transmitted to the navigation module 320 to plan the route. The intelligent robot control module 330 may generate control parameters of the intelligent robot 110 based on the route planned by the navigation module 320. In some embodiments, the control parameters may be temporarily stored in the storage 220. In some embodiments, the control parameters may be transmitted to the robot body 260 to control a movement of the intelligent robot 110. Descriptions of the control parameter may be found elsewhere in the present disclosure. See, e.g., FIG. 6, FIG. 7 and the descriptions thereof.

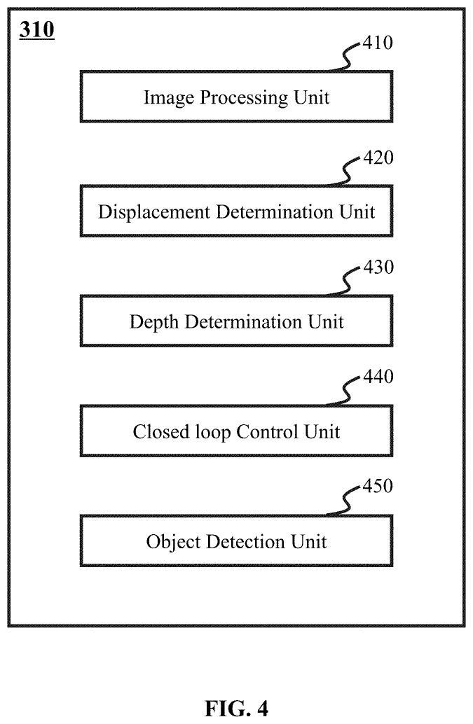

FIG. 4 is a block diagram illustrating an exemplary analysis module 310 in the processor 210 illustrated in FIG. 3 according to some embodiments of the present disclosure. In some embodiments, the analysis module 310 may include an image processing unit 410, a displacement determination unit 420, a depth determination unit 430, a closed loop control unit 440, and an object detection unit 450.

The image processing unit 410 may process image data to implement one or more functions of the intelligent robot 110. For example, the image data may include one or more images (e.g., still images, video frames, etc.), an initial depth and an initial displacement of each pixel in each frame, and/or any other data associated with the one or more images. In some embodiments, the displacement may include a displacement of a wheel within a time interval and a displacement of a camera relative to the wheel within the time interval. Two adjacent frames may be obtained within the time interval. The image data may be provided by any device capable of providing the image data, such as the sensor(s) 230 (e.g., one or more image sensors). In some embodiments, the image data may include data associated with a plurality of images. The images may include a sequence of video frames (also referred to as “frames”). Each of the frames may include a frame, a field, etc.

In some embodiments, the image processing unit 410 may process the image data to generate movement information of the intelligent robot 110. For example, the image processing unit 410 may process two frames (e.g., a first frame and a second frame) to determine a difference between the two frames. Then the image processing unit 410 may generate the movement information of the intelligent robot 110 based on the difference between the two frames. In some embodiments, the first frame and the second frame may be adjacent frames (e.g., a current frame and a previous frame, a current frame and a subsequent frames, etc.). In addition, the first frame and the second frame may be non-adjacent frames. More specifically, for example, the image processing unit 410 may determine one or more corresponding pixels in the first frame and the second frame and one or more regions (also referred to as “overlapping regions”) including the one or more corresponding pixels. In response to a determination that a first pixel and a second pixel correspond the same object, the image processing unit 410 may determine the first pixel in the first frame as the corresponding pixel of the second pixel in the second frame. The first pixel and the corresponding pixel in the second frame (e.g., the second pixel) may correspond to the same location of the same object. In some embodiments, the image processing unit 410 may identify one or more pixels in the first frame that fail to correspond to one or more pixels in the second frame. The image processing unit 410 may further identify one or more regions (also referred to as “non-overlapping regions”) including the identified pixels. The non-overlapping regions may correspond to a movement of the sensor(s) 230. In some embodiments, pixels in the non-overlapping regions in the first frame that fail to correspond to one or more pixels in the second frame may be omitted for further processing (e.g., processing by the displacement determination unit 420 and/or the depth determining unit 430).

In some embodiments, the image processing unit 410 may identify intensities of pixels in the first frame and the corresponding pixels in the second frames. In some embodiments, the intensities of the pixels in the first frame and the corresponding pixels in the second frames may be obtained as a standard for determining the difference between the first frame and the second frame. For example, the RGB intensity may be selected as a standard for determining the difference between the first frame and the second frame. The pixels, the corresponding pixels and the RGB intensities may be transmitted to the displacement determination unit 420 and/or the depth determination unit 430 for determining the displacement and the depth of the second frame. In some embodiments, the depth may represent a space depth of an object in the two frames. In some embodiments, the displacement information may include a set of displacements of a set of frames. In some embodiments, the depth information may include a set of depths of a set of frames. The frames, the displacement information, and the depth information may be used to construct the map.

The displacement determination unit 420 may determine the displacement information based on data provided by the image processing unit 410 and/or any other data. The displacement information may include one or more displacements that may represent movement information of the sensor(s) 230 that generates image data (e.g., an image sensor that captures a plurality of frames). For example, the displacement determination unit 420 may obtain data of the corresponding pixels in the two frames (e.g., the first frame and the second frame). The data may include one or more values corresponding to the pixels, such as gray values, intensities of the pixels, or the like. The displacement determination unit 420 may determine the values corresponding to the pixels based on any suitable color model (e.g., a RGB (red, green, and blue) model, an HSV (hue, saturation, and brightness) model, etc.). In some embodiments, the displacement determination unit 420 may determine a difference between pairs of corresponding pixels in two frames. For example, the image processing unit 410 may identify a first pixel in the first frame and a corresponding pixel in the second frame (e.g., a second pixel). The second pixel may be determined based on a transformation of coordinates of the first pixel. The first pixel and the second pixel may correspond to the same object. The displacement determination unit 420 may also determine a difference between a value of the first pixel and a value of the second pixel. In some embodiments, a displacement may be determined by minimizing a sum of the differences between the pairs of corresponding pixels in the first frame and the second frame.

In some embodiments, the displacement determination unit 420 may determine an initial displacement ξ_{ji,1} indicating estimated value of the displacement from an origin. For example, the initial displacement ξ_{ji,1} may be determined based on Equation (1) as below:

$${ξ}_{ji , 1} = {argmin}_{{ξ}_{ji}} {\int }_{Ω} {\vert {I}_{i} ( x ) - {I}_{j} ( ω ( x , {D}_{i} ( x ) , {ξ}_{ji} ) ) \vert}_{δ} dx \qquad ( 1 )$$

wherein, x represents coordinates of a pixel in the first frame, ω(x, Dᵢ(x), ξⱼᵢ) represents coordinates of a corresponding pixel in the second frame, ω(x, Dᵢ(x), ξⱼᵢ) and Iᵢ(x) may be at the same location of an object, and ω(x, Dᵢ(x), ξⱼᵢ) is a transformed pixel of x after a certain displacement ξⱼᵢ of a camera. Ω is a set of pairs of pixel. Each pair of pixels may include a pixel in the first frame and a corresponding pixel in the second frame. Iᵢ(x) is a RGB intensity of pixel x; Iⱼ(ω(x, Dᵢ(x), ξⱼᵢ)) is a RGB intensity of pixel ω(x, Dᵢ(x), ξⱼᵢ).

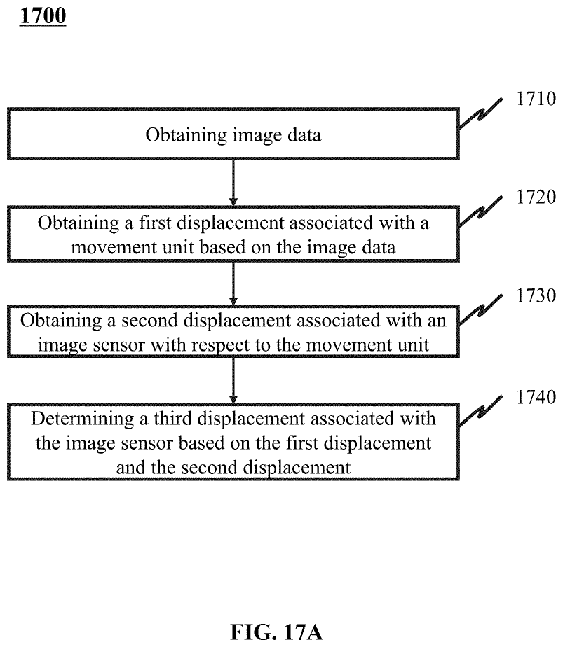

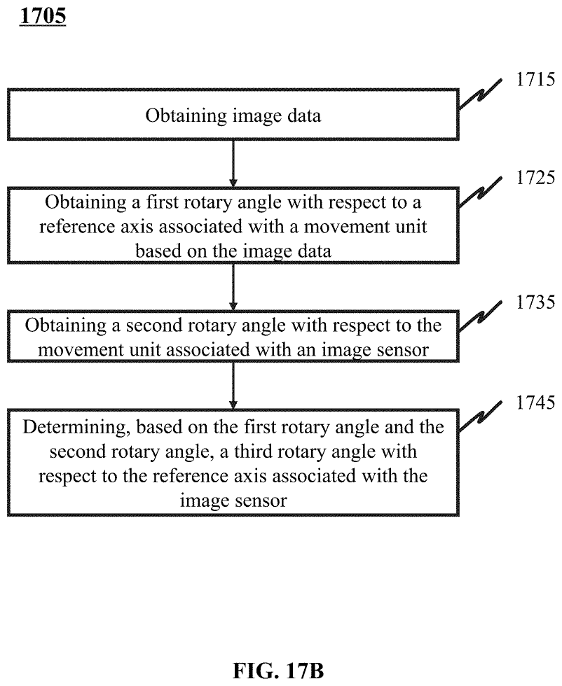

ω(x, Dᵢ(x), ξⱼᵢ) is the transformed coordinate of pixel x after the displacement of the camera. In some embodiments, the displacement determination unit 420 may calculate the corresponding pixel ω(x, Dᵢ(x), ξⱼᵢ) based on an initial value of ξⱼᵢ and an initial depth Dᵢ(x). In some embodiments, the initial depth Dᵢ(x) may be a zero matrix. ξⱼᵢ may be a variable. In order to obtain ξ_{ji,1}, the displacement determination unit 420 may need the initial value of ξⱼᵢ as shown in the iteration function (1). In some embodiments, the initial value of ξⱼᵢ may be determined based on a displacement ξⱼᵢ′ of wheels and a displacement ξⱼᵢ″ of a camera relative to the wheels. Descriptions of the initial value of ξⱼᵢ may be found elsewhere in the present disclosure. See, e.g., FIG. 17A and the descriptions thereof. In some embodiments, the initial value of the displacement may be a vector sum of ξⱼᵢ′ and ξⱼᵢ″. Trying initial values and variables around the initial value of ξⱼᵢ, the minimum difference between the two frames may be obtained.

In some embodiments, the depth determination unit 430 may determine an updated depth D_{i,1}(x). The updated depth D_{i,1}(x) may be calculated by Equation(2):

$${D}_{i , 1} ( x ) = {argmin}_{{D}_{i} ( x )} {\int }_{Ω} {\vert {I}_{i} ( x ) - {I}_{j} ( ω ( x , {D}_{i} ( x ) , {ξ}_{ji , 1} ) ) \vert}_{δ} dx \qquad ( 2 )$$

wherein depth Dᵢ(x) represents a variable for the difference between the two frames in Equation (2). When the difference between the two frames is the smallest, a value of D_{i,1}(x) may be determined as the updated depth. In some embodiments, the initial depth Dᵢ(x) may be a zero matrix.

The displacement determination unit 420 may also generate an updated displacement ξ_{ji,1u} based on the updated depth D_{i,1}(x). In some embodiments, the updated displacement ξ_{ji,1u} may be obtained based on Equation (1) by replacing the initial depth Dᵢ(x) with the updated depth D_{i,1}(x).

The closed loop control unit 440 may implement closed loop detection. The closed loop control unit 440 may detect whether the intelligent robot 110 returns to a previously visited location and update displacement information based on the detection. In some embodiments, in response to a determination that the intelligent robot 110 has returned to the previously visited position in a route, the closed loop control unit 440 may adjust the updated displacement of frames using a g2o closed loop detection to reduce errors. The g2o closed loop detection may be a general optimization framework for reducing non-linear errors. The adjusted updated displacements of frames may be set as displacement information. In some embodiments, if the intelligent robot 110 includes a depth sensor such as a Lidar, the depth may be directly obtained, the displacement may be determined based on Equation (1), and then the displacement may be adjusted by the closed loop control unit 440 to generate an adjusted displacement.

Firstly, when the depth information is detected by the depth sensor, the displacement information may include a set of displacements based on Equation (1), and then adjusted by the closed loop control unit 440. When the depth information is a set of updated depths, the displacement information may include a set of displacements after calculating Equation (1), Equation (2), and adjusted by the closed loop control unit 440.

In some embodiments, the closed loop control unit 440 may generate a map based on frames, the displacement information, and the depth information.

The analysis module 310 may also include an object detection unit 450 that may detect obstacles, objects, and distances from the intelligent robot 110 to the obstacles and the objects. In some embodiments, the obstacles and the objects may be detected based on data obtained by the sensor(s) 230. For example, the object detection unit 450 may detect the objects based on distance data captured by a sonar, an infrared distance sensor, an optical flow sensor, or a Lidar.

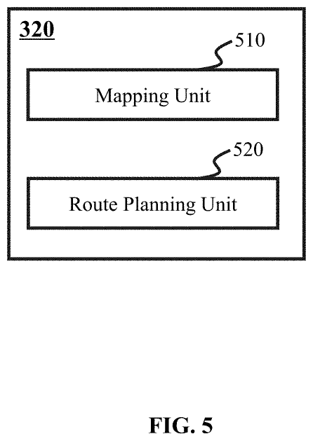

FIG. 5 is a block diagram illustrating an exemplary navigation module 320 in the processor 210 according to some embodiments of the present disclosure. In some embodiments, the navigation module 320 may include a mapping unit 510 and a route planning unit 520. In some embodiments, the mapping unit 510 may receive a map from the database 140. In some embodiments, the mapping unit 510 may process the map for route planning. In some embodiments, the map may be a portion of an entire map in the database 140. For example, a map including a determined destination and a determined location of the intelligent robot 110 may be suitable for planning the route. In some embodiments, the map obtained from the database 140 may be a 3D map. In some embodiments, the mapping unit 510 may transfer the 3D map into a 2D map using a projection technique. That is, the mapping unit 510 may segment objects in the 3D map into pixels and project the pixels to the horizontal surface to generate the 2D map. Once the 2D map is obtained by the mapping unit 510, the route planning unit 520 may plan the route from the location of the intelligent robot 110 to the destination based on the transferred 2D map.

The intelligent robot control module 330 may determine control parameters based on the route planned by the route planning unit 520 in the navigation module 320. In some embodiments, the intelligent robot control module 330 may segment the route into a set of segments. The intelligent robot control module 330 may obtain a set of joints of the segments. In some embodiments, a joint between two segments may be a destination of a previous segment and a start location of a subsequent segment. Control parameters for the segment may be determined based on the destination and the start location.

In some embodiments, during the movement of the intelligent robot 110 in the segment, the destination of the intelligent robot 110 may mismatch with a predetermined destination of the segment. The route planning unit 520 may plan a new route based on the mismatched destination (a new location of the intelligent robot 110) and the predetermined destination. In some embodiments, the intelligent robot control module 330 may segment the new route and generate one or more new segments. The intelligent robot control module 330 may determine a set of control parameters for each new segment.

FIG. 6 and FIG. 7 are examples of movement control of the intelligent robot 110. As shown in FIG. 6, a movement module moves around a point ICC with an angular velocity ω. The movement module has two wheels, including a left wheel 610 moving with velocity vₗ and a right wheel 620 moving with velocity vᵣ. In some embodiments, a distance between the left wheel 610 and the right wheel 620 is L. A distance from the left wheel 610 and the right wheel 620 to a central point O of the two wheels are both L/2. A distance between the central point O and the point ICC is R.

FIG. 7 is a block diagram for determining control parameters of the intelligent robot 110. As shown in FIG. 7, a movement module of the intelligent robot 110 moves from point O₁ to point O₂ within cit. An angle between a line connected by Point O₁ and point ICC and a line connected by point O₂ and point ICC is α. With dt, L, R and a, velocity vₗ of the left wheel and velocity vᵣ of the right wheel may be determined.

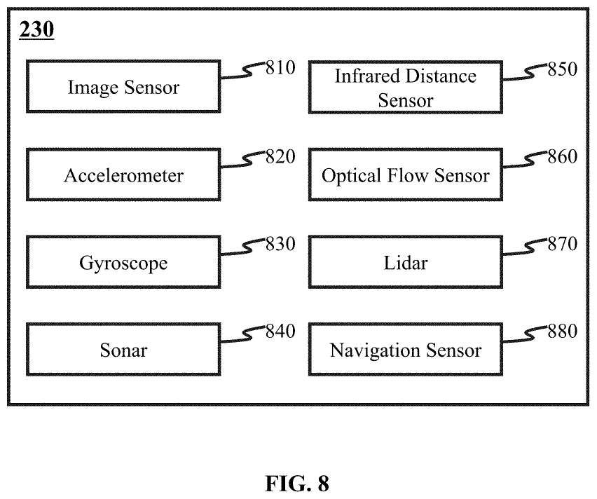

FIG. 8 is a block diagram illustrating the sensor(s) 230 according to some embodiments of the present disclosure. The sensor(s) 230 may include an image sensor 810, an accelerometer 820, a gyroscope 830, a sonar 840, an infrared distance sensor 850, an optical flow sensor 860, a Lidar 870, and a navigation sensor 880.

The image sensor 810 may capture image data. In some embodiments, based on the image data, the analysis module 310 may construct a map. In some embodiments, the image data may include frames, an initial depth and an initial displacement of each pixel in each frame. In some embodiments, the initial depth and the initial displacement may be used to determine a depth and a displacement. Descriptions of determining the depth and the displacement may be found elsewhere in the present disclosure. See, e.g., Equation (1) in FIG. 4. In some embodiments, the displacement may include a displacement of a wheel and a displacement of a camera relative to the wheel between two time points at which two adjacent frames are captured.

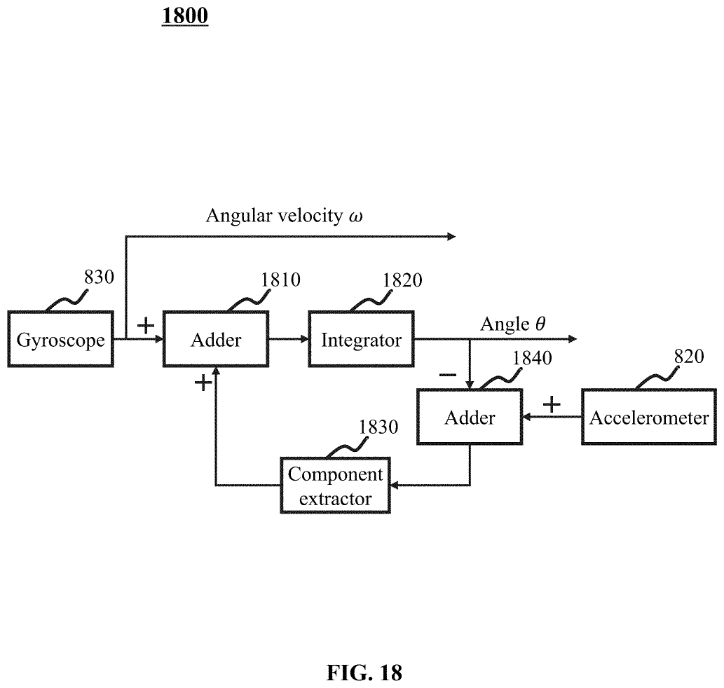

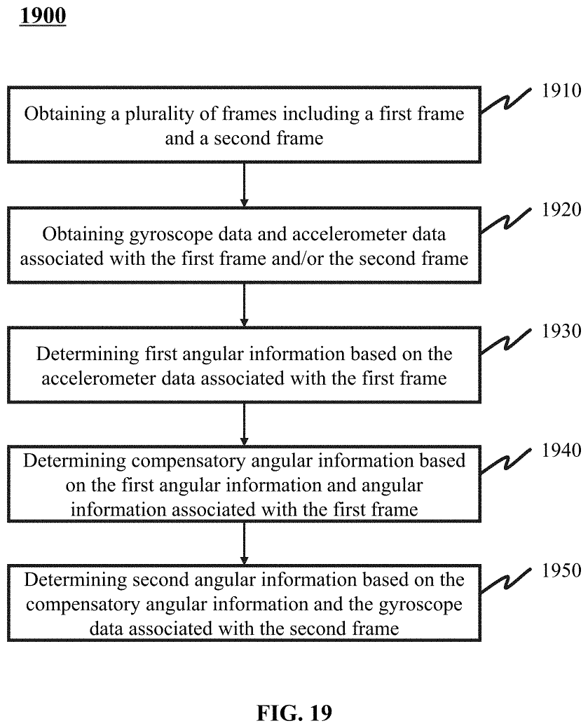

The accelerometer 820 and the gyroscope 830 may operate together to keep balance of a movement module and a holder. The balance may be necessary for obtaining stable information from the sensor(s) 230. In some embodiments, the accelerometer 820 and the gyroscope 830 may operate together to control a pitch attitude within a threshold. In some embodiments, the accelerometer 820 and the gyroscope 830 may be supported by the movement module and the holder, respectively. Description of keeping balance may be found elsewhere in the present disclosure. See, e.g., FIG. 18 and FIG. 19, and the descriptions thereof.

The sonar 840, the infrared distance sensor 850, and the optical flow sensor 860 may be used to locate the intelligent robot 110. In some embodiments, the intelligent robot 110 may be located by the sonar 840, the infrared distance sensor 850, or the optical flow sensor 860, or any combination thereof.

The Lidar 870 may detect a depth of an object in a frame. That is, the Lidar 870 may obtain a depth for each frame, and it may be unnecessary to calculate the depth by the analysis module 310 in the processor 210. The depth obtained by the Lidar 870 may be used to calculate the displacement described in Equation (1) in FIG. 4 directly. The displacement obtained based on Equation (1) may be adjusted by the closed loop control unit 440.

The sonar 840, the infrared distance sensor 850, and the optical flow sensor 860 may locate the intelligent robot 110 by detecting a distance between the intelligent robot 110 and an object or an obstacle. The navigation sensor 880 may position the intelligent robot 110 within a rough region or a location range. In some embodiments, the navigation sensor 880 may locate the intelligent robot 110 with any type of positioning systems. The positioning system may include a Global Positioning System (GPS), a Beidou navigation or positioning system, and a Galileo positioning system.

FIG. 9 is an exemplary block diagram illustrating the robot body 260 described in FIG. 2 according to some embodiments of the present disclosure. The robot body 260 may include a housing 910, a movement module 920, and a holder 930. The housing 910 may include a shield of the robot body 260 that protects modules and units in the intelligent robot 110. The movement module 920 may be a movement operating component in the intelligent robot 110. In some embodiments, the movement module 920 may move based on control parameters generated by the intelligent robot control module 330 in the processor 210. For example, with respect to a segment of a route determined by the intelligent robot control module 330, control parameters may be determined based on a start location and a destination of the segment. The control parameters may be transmitted from the intelligent robot control module 330 to the movement module 920 to make the intelligent robot 110 move from the start location to the destination. In some embodiments, the holder 930 may be a supporting component for at least one of the sensors described in FIG. 8. The holder 930 may support the image sensor 810, such as a camera, to obtain frames. In some embodiments, the holder 930 may support the accelerometer 820 and the gyroscope 830. The stable information may be obtained by maintaining balance of the sensors supported by the holder 930. In some embodiments, the holder 930 may support at least one of the sonar 840, the infrared distance sensor 850, and the optical flow sensor 860 to detect a distance between the intelligent robot 110 and an object or an obstacle. In some embodiments, the holder 930 may also support the Lidar 870 and other sensors to detect depth information or other information. In some embodiments, the navigation sensor 880 may be installed on the holder 930. In some embodiments, sensors held by the holder may be integrated into an intelligent phone.

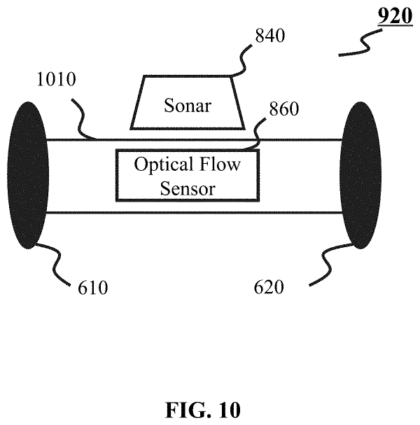

FIG. 10 is an exemplary schematic diagram illustrating the movement module 920. The movement module 920 may include a movement unit and a carrier 1010. The movement unit may have two wheels including a left wheel 610 and a right wheel 620. The carrier 1010 may carry the sonar 840 or the optical flow sensor 860 to detect objects or obstacles. In some embodiments, the carrier 1010 may include the accelerometer 820 (not shown in FIG. 10) and the gyroscope 830 (not shown in FIG. 10) to keep balance of the movement module 920. In some embodiments, the carrier 1010 may include other sensors, such as the infrared distance sensor 850, to obtain other required information.

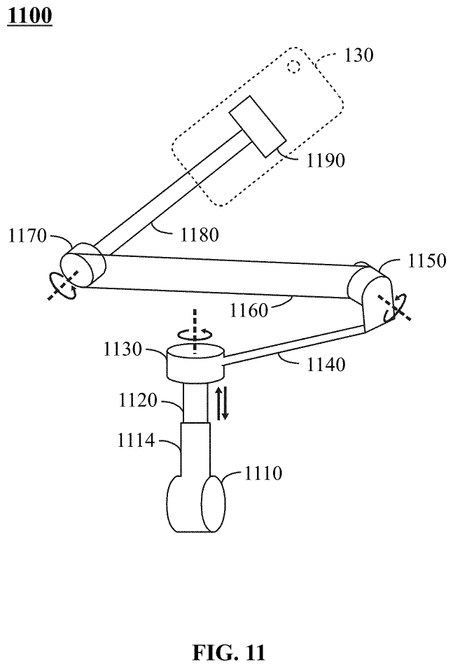

As shown in FIG. 9, the holder 930 may support the sensor(s) 230 to obtain information to generate a map, plan a route, or generate control parameters. FIG. 11 is an exemplary diagram illustrating the holder 930 in the robot body 260 described in FIG. 9 according to some embodiments of the present disclosure. In some embodiments, the holder 930 may include a rotor 1170 controlling rotation around the X axis, a rotor 1150 controlling rotation around the Y axis and a rotor 1130 controlling rotation around the Z axis. The X axis may be a first axis in a horizontal plane. The Y axis may be a second axis in the horizontal plane. The Z axis may be a vertical axis perpendicular to the horizontal plane. In some embodiments, the holder 930 may include a rod 1180 connecting the rotor 1170 and the sensors, a rod 1160 connecting the rotor 1150 and the rotor 1170, and a rod 1140 connecting the rotor 1130 and the rotor 1150. In some embodiments, the holder 930 may include a connecting component 1110 and a connecting rod 1114, and a dynamic Z-buffering rod 1120. In some embodiments, the sensors may be integrated in the user device 130 (e.g., an intelligent phone). The user device 130 may include sensors such as the image sensor 810, the accelerometer 820, the gyroscope 830, and the navigation sensor 880. The holder 930 may also include a connection block 1190 for supporting the user device 130. During operation of the holder 930, information may be obtained by the sensors in the user device 130. In some embodiments, the sensors in the user device 130 may be controlled by adjusting an attitude of the holder 930 to obtain proper information. In some embodiments, the attitude of the holder 930 may be adjusted by rotating the rotor 1170, the rotor 1150 and the rotor 1130 around the X axis, the Y axis and the Z axis.

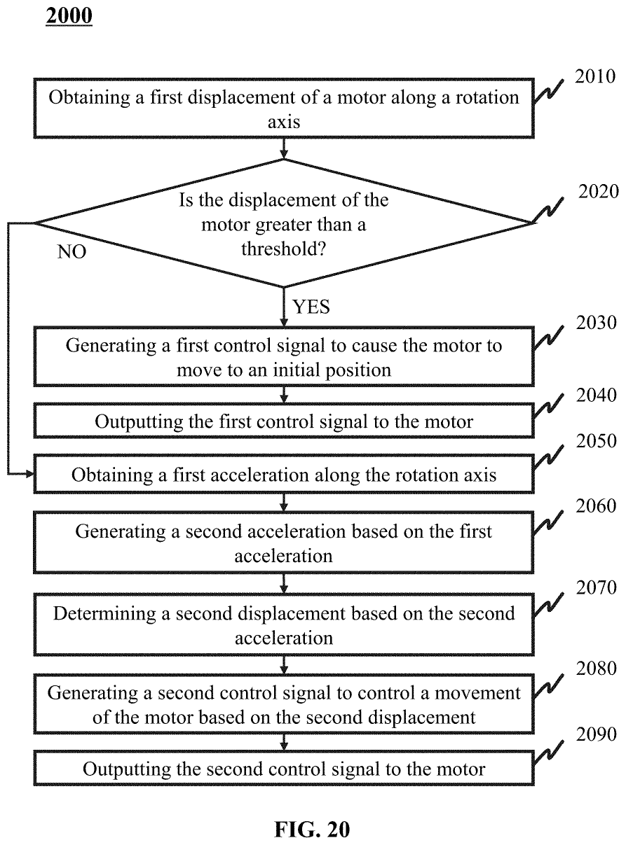

A traditional 3-axis holder may be used for aerial photography. In order to keep the stability of the holder 930 during movement along a route, the dynamic Z-buffering rod 1120 may be adopted in the holder 930. The dynamic Z-buffering rod 1120 may keep the stability of the holder 930 along the Z-axis. In some embodiments, the dynamic Z-buffering rod 1120 may include a retractable rod that may extend and retract along the Z-axis. The process for operating the dynamic Z-buffering rod 1120 in the holder 930 may be illustrated in FIG. 20. Rotation of the rotor 1130, 1150 and 1170 and vertical movement of the dynamic Z-buffering rod 1120 may be controlled based on the control parameters generated by the intelligent robot control module 330.

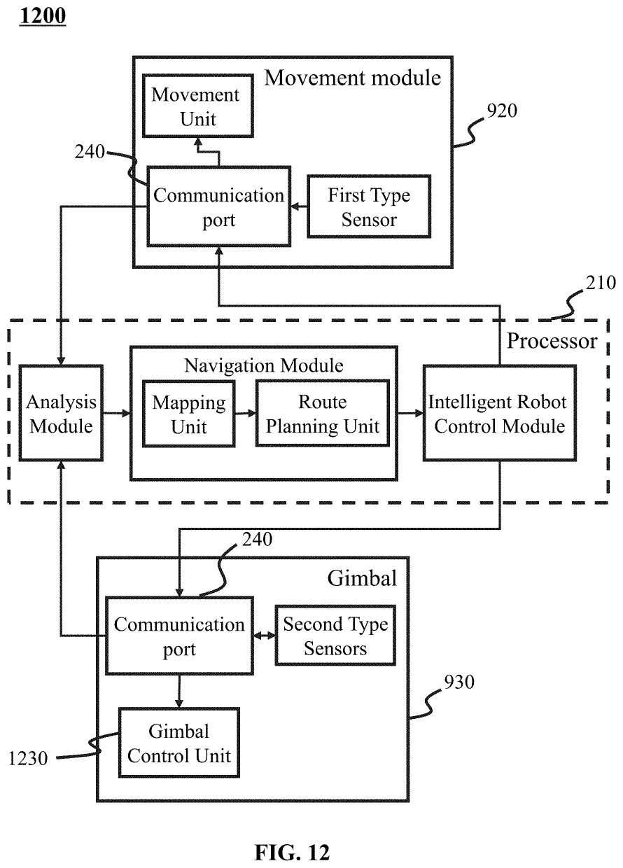

The intelligent robot 110 may include a plurality of modules and units. FIG. 12 shows a simple system of the intelligent robot 110 according to some embodiments of the present disclosure. As shown in FIG. 12, the intelligent robot 110 may include a processor 210, a movement module 920, and a holder 930. In some embodiments, the processor 210 may include an analysis module 310, a navigation module 320, and an intelligent robot control module 330. The movement module 920 may include a movement unit 1210, a first type sensor 1220, and a communication port 240. The holder 930 may include a holder control unit 1230, a communication port 240, and a second type sensor 1240. In some embodiments, the processor 210 may transmit control parameters to control the movement unit 1210 in the movement module 920 and the holder control unit 1230 in the holder 930.

In some embodiments, the first type sensor 1220 and the second type sensor 1240 may obtain information. The analysis module 310 may process the obtained information and construct a map. In some embodiments, the constructed map may be transmitted to the database 140. For determining a route to a destination, a map may be needed for navigation. The analysis module 310 may download the latest map from the database 140 and transmit the latest map to the navigation module 320. The navigation module 320 may process the latest map and determine the route from the location to the destination of the intelligent robot. In some embodiments, the analysis module 310 may be unnecessary to download an entire map. A portion of the entire map including the location and the destination of the intelligent robot 110 may be enough for planning the route. In some embodiments, the map constructed by the analysis module 310 may include the location and the destination of the intelligent robot 110, and the map may be the latest map in the database. The map constructed by the analysis module 310 may be transmitted to the navigation module 320 to plan the route. The navigation module 320 may include the mapping unit 510 and the route planning unit 520. In some embodiments, based on the latest map or the constructed map from the analysis module 310, the mapping unit 510 may generate a 2D map for route planning. The route planning unit 520 may plan the route transmitted to the intelligent robot control module 330. The intelligent robot control module 330 may segment the route into one or more segments. The intelligent robot control module 330 may generate control parameters for each segment. For each segment, a start location and a destination may exist. A destination of the segment may be a start location of a subsequent segment. In some embodiments, a location stopped by the intelligent robot 110 for the segment may mismatch with a predetermined destination of the segment, which may influence the remaining portion of the route. Thus, it is necessary to re-plan a route based on the mismatched location (a new location of the intelligent robot 110) and the destination. In some embodiments, after each segment, the re-planning process may be operated by the navigation module 320 if the mismatching is detected.

In some embodiments, information captured by the first type sensors 1220 in the movement module 920 and the second type sensors 1240 in the holder 930 may be improper to construct the map if the first type sensors 1220 in the movement module 920 and the second type sensors 1240 in the holder 930 are unstable. The intelligent robot control module 330 may generate control parameters to adjust an attitude of the movement module 920 and the holder 930 to stabilize the first type sensors 1220 and the second type sensors 1240.

Sensors may be installed on the movement module 920 and the holder 930. In some embodiments, the first type sensor 1220 may include at least one of an accelerometer 820, a gyroscope 830, a sonar 840, an infrared distance sensor 850, an optical flow sensor 860, a Lidar 870, and a navigation sensor 880. In some embodiments, the second type of sensor 1240 may include at least one of an image sensor 810, an accelerometer 820, a gyroscope 830, a sonar 840, an infrared distance sensor 850, an optical flow sensor 860, a Lidar 870, and a navigation sensor 880.

As shown in FIG. 12, the processor 210 may establish communication between the movement module and the holder 930 via the communication port 240. In some embodiments, the communication port 240 may be in any form. For example, the communication port 240 may include a wired or wireless transceiver. In some embodiments, the communication port 240 may exist in the form of an interface for interactive communication. For example, communication port 240 may establish communication between the processor 210 and other portions of the intelligent robot 110 by circuits using an application programming interface (API). In some embodiments, the API may include a set of subroutine definitions, protocols, and tools for building software and applications. In some embodiments, the API may make it easier to develop a program by providing all building blocks, which are then put together. In some embodiments, the API protocol may be used to design a circuit for wireless communication such as Wi-Fi, Bluetooth, Infrared (IR), Ultra-Wide band (UWB), ZigBee, or the like, or as a mobile communication module, such as 3G, 4G, or Long Term Evolution (LTE). The API may separate bottom hardware (e.g., the movement module 920 or the holder 930) and control hardware (e.g., the processor 210). In some embodiments, the processor 210 (e.g., a portion of an intelligent phone) may control movements of wheels in the movement module 920 and attitudes of image sensors (e.g., a camera) in the holder 930 by implementing the API in the communication port 240. In some embodiments, the first type sensor 1220 in the movement module 920 may transmit information (e.g., location data) to the intelligent phone. In some embodiments, the second type sensor 1240 in the holder 930 may send information (e.g., camera attitude) to the intelligent phone.

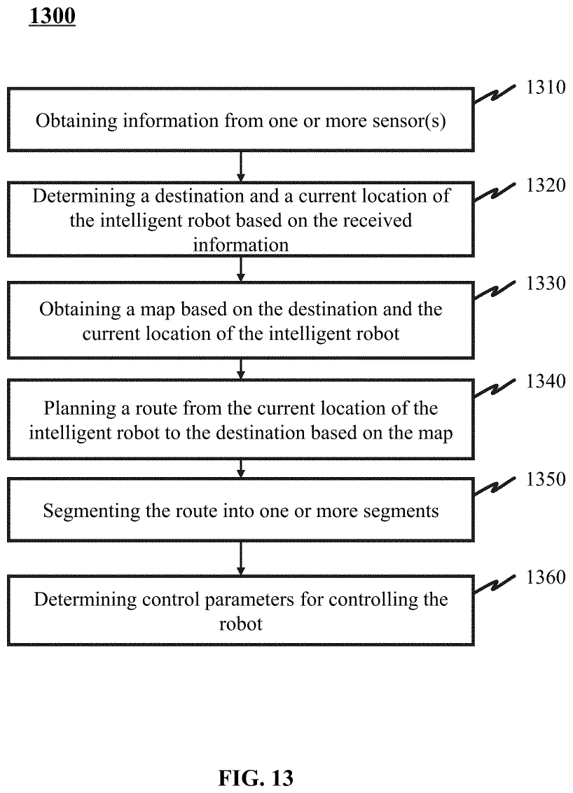

FIG. 13 is an exemplary flowchart for determining control parameters to control an intelligent robot according to some embodiments of the present disclosure. The process 1300 described in FIG. 13 may be implemented by the processor 210 of the intelligent robot 110 based on instructions stored in the storage 220.

In 1310, the processor 210 may obtain information from the sensor(s) 230. As described in FIG. 3 and FIG. 12, the analysis module 310 in the processor 210 may receive the information from the first type sensors 1220 in the movement module 920 and the second type sensors 1240 in the holder 930 via the API communication port 240. In some embodiments, the information may be analyzed to control a movement of the intelligent robot 110. In some embodiments, the information may be analyzed to maintain stabilization of the movement module 920 and the holder 930 in the intelligent robot 110.

In 1320, the processor 210 may determine a destination and a current location of the intelligent robot 110 based on the received information. For example, the analysis module 310 in the processor 210 may receive location data from the sensor(s) 230. The sensor(s) 230 may include, but are not limited to, a sonar, an infrared distance sensor, an optical flow sensor, a Lidar, a navigation sensor, or the like. In some embodiments, a user may determine the destination via the input/output (I/O) interface 250. For example, the user may input the destination of the intelligent robot 110. The information of the destination may be used by the processor 210 to provide a route for the movement of the intelligent robot 110. In some embodiments, the processor 210 may determine the current location of the intelligent robot 110 based on the received information. In some embodiments, the processor 210 may determine the current location of the intelligent robot 110 based on information obtained from the sensor(s) 230. For example, the processor 210 may determine a rough location of the intelligent robot 110 based on information obtained by the navigation sensor 880 in the positioning system (e.g., GPS). As another example, the processor 210 may determine a precise location of the intelligent robot 110 according to information obtained by at least one of the sonar 840, the infrared distance sensor 850, and the optical flow sensor 860.

In 1330, the processor 210 may obtain a map based on the destination and the current location of the intelligent robot 110. The map may be used to plan a route. In some embodiments, an entire map including a plurality of points representing a city may be stored in the database 140. After the destination and the current location of the intelligent robot 110 are determined by the processor 210 in 1310 and 1320, a map including the current location of the intelligent robot 110 and the destination may be needed for planning a route between the current location and the destination. In some embodiments, the map including the current location of the intelligent robot 110 and the destination may be a portion of the entire map. In some embodiments, the analysis module 310 in the processor 210 may obtain a suitable portion of the entire map from the database 140 based on the destination and the current location of the intelligent robot 110. In some embodiments, the analysis module 310 may construct a map based on the information obtained from the sensor(s) 230. The constructed map may be transmitted to the database 140 to update the entire map. In some embodiments, the constructed map may include the destination and the current location of the intelligent robot 110. The constructed map may be used by the navigation module 320 to plan a route.

In 1340, the route may be planned from the current location of the intelligent robot 110 to the destination based on the obtained map in 1330. The planning of the route may be implemented by the navigation module 320. In some embodiments, as illustrated in FIG. 12, the navigation module 320 may convert the obtained map to a 2D map by the mapping unit 510. The route planning unit 520 may then plan the route from the current location of the intelligent robot 110 to the destination based on the 2D map.

In 1350, the intelligent robot control module 330 may segment the planned route into one or more segments. The segmentation of the route may be based on a threshold. For example, if the length of the planned route is shorter than a threshold, the segmentation of the route may be not implemented. In some embodiments, the segmentation may be implemented by the intelligent robot control module 330 based on instructions stored in the storage 220.

In 1360, the intelligent robot control module 330 may determine control parameters for controlling the robot based on the one or more segments in 1350. In some embodiments, each segment segmented by the intelligent robot control module 330 in 1350 may have a start location and a destination. In some embodiments, the intelligent robot control module 330 may determine control parameters for the segment based on the start location and the destination. Examples for determining control parameters between two locations may be found in FIG. 6 and FIG. 7. In some embodiments, the control parameters may be continuously adjusted according to time. For example, when the intelligent robot 110 traverses two locations (i.e., a first location, a second location) in a straight line of a segment, the intelligent robot 110 may move with different velocities within different time periods from the first location one to the second location. In some embodiments, the control parameters may be used to stabilize the intelligent robot during movement along the planned route. For example, the movement module 920 and the holder 930 may be stabilized so that information sensed by thereof may be more accurately. As another example, if the planned route is bumpy, the control parameters may be used to maintain the stability of the holder 930 along the vertical axis.

In some embodiments, when the intelligent robot 110 passes through a segment based on predetermined control parameters, the intelligent robot 110 may stop at a location which mismatches with a destination for the segment predetermined by the intelligent robot control module 330. The navigation module 320 may re-plan a new route based on the mismatched location and the destination of the intelligent robot 110. The intelligent robot control module 330 may further segment the new planned route into one or more segments. The intelligent robot control module 330 may determine new control parameters of the intelligent robot 110 for the one or more new segments. In some embodiments, the mismatching with the destination may be estimated according to the comparison between a stopped location and a predetermined destination for each segment of the intelligent robot 110 after the intelligent robot 110 passes the segment.

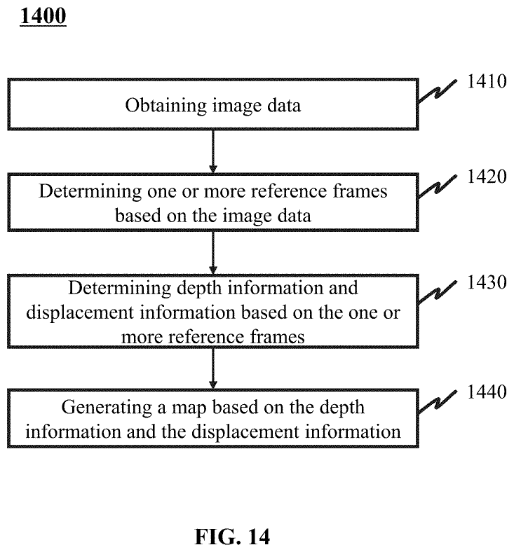

FIG. 14 is a flowchart illustrating a process for constructing a map by the processor 210 according to some embodiments of the present disclosure. The process for constructing the map may be implemented by the analysis module 310 based on information obtained by the sensor(s) 230.

In 1410, the analysis module 310 may obtain image data from the image sensor 810. In some embodiments, the image data may include a plurality of frames, an initial depth and/or displacements for each pixel in the plurality of frames. The displacements may include a displacement of a wheel and a displacement of a camera relative to the wheel. In some embodiments, the initial depth may be set as a zero matrix. In some embodiments, if a Lidar or a camera with a depth detecting function is included in the sensor(s) 230, depth information (e.g., the initial depth) may be obtained by the sensor(s).

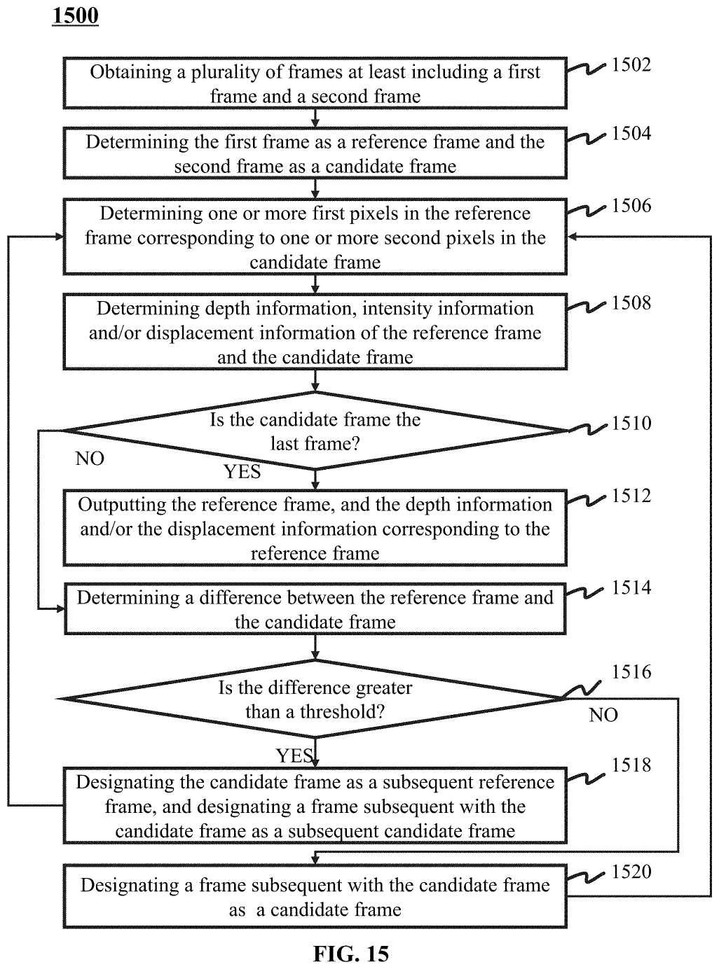

In 1420, one or more reference frames may be determined by the analysis module 310 based on the image data. In some embodiments, the image data may include the plurality of frames, the initial depth and/or the displacements for each pixel in the frames. In some embodiments, the analysis module 310 may select the one or more reference frames from the plurality of frames. Detailed descriptions can be found elsewhere in the present disclosure. See e.g., FIG. 15 and the description thereof. In some embodiments, the one or more reference frames may be used to construct the map.

In 1430, the analysis module 310 may determine depth information and displacement information based on the one or more reference frames. That is, the image data may be processed by the analysis module 310 for obtaining displacement information and depth information for each frame. The process for determining the displacement information and the depth information may be found elsewhere in the present disclosure, e.g., see FIG. 4, and the description thereof.

In 1440, the analysis module 310 may construct the map based on the one or more reference frames, the depth information and the displacement information of the one or more reference frames. In some embodiments, a 3D map may be constructed by connecting the one or more reference frames with displacements corresponding to the one or more reference frames.

The map may be determined based on the plurality of frames and the displacement information and the depth information corresponding to the plurality of frames. In some embodiments, operations 1420 and 1430 may be implemented in inverted order, or simultaneously. For example, operation 1420 for determining the one or more reference frames may include determining the displacement information and the depth information as illustrated in 1430. That is, operation 1430 may be a sub-step of the operation 1420 for determining the one or more reference frames. As described in FIG. 4, the image data may be processed and one or more results may be generated. In some embodiments, the one or more results may include the displacement information (e.g., a displacement of a camera within two adjacent frames) and the depth information (e.g., a depth of an object in two adjacent frames). In some embodiments, the one or more results may be adjusted by a g2o closed loop detection technique to generate adjusted displacement information. In some embodiments, the adjusted displacement information may be used as displacement information to construct the map. The analysis module 310 may generate the map based on the one or more reference frames and the displacement information and the depth information corresponding to the one or more reference frames.

FIG. 15 is an exemplary flowchart illustrating a process for determining one or more reference frames according to some embodiments of the present disclosure. The process may be implemented by the analysis module 310, the displacement determination unit 420 and the depth determination unit 430 based on the image data obtained by the image sensor 810. Specifically, the analysis module 310 may determine the one or more reference frames based on the one or more results (e.g., the displacement information and the depth information).

In 1502, the analysis module 310 may obtain image data including a plurality of frames. The plurality of frames may at least include a first frame and a second frame. In some embodiments, the first frame may be an existing frame, and the second frame may be a subsequent frame of the first frame. That is, the image sensor 810 may capture the first frame at a moment and capture the second frame at a subsequent moment. That is, the plurality of frames may be adjacent to each other in the time domain.

In some embodiments, based on the image data that has been obtained, the analysis module 310 may preprocess the image. Mere by way of example, the preprocessing the image may include image segmentation, image enhancement, image fusion, image compression, or the like, or any combination thereof.

In some embodiments, techniques for the image segmentation may include a wavelet transform technique, a Gabor transform technique, a morphological image processing technique, an image frequency domain processing technique, a histogram-based technique (e.g., a color histogram-based technique, an intensity histogram-based technique, an edge histogram-based technique, etc.), a compression-based technique, a region growing technique, a technique based on partial differential equation, a variational technique, an image segmentation technique, a watershed transform technique, a model-based segmentation technique, a multi-scale segmentation technique, a triangulation technique, a co-occurrence matrix technique, an edge detection technique, a threshold technique, or the like, or any combination thereof.

In some embodiments, the image enhancement may include enhancing one or more properties of the image. The one or more properties of the image may include a contrast (local or global), a brightness (local or global), a saturation (local or global), a sharpness (local or global), a grayscale of the image, or the like, or any combination thereof.

In some embodiments, the analysis module 310 may determine one or more historical space features from the images. The space features may relate to an integral pixel intensity, a local pixel intensity (an integral or a local brightness), a location of an object, a length of an object or a size of an object (e.g., a plane, a protrusion, an obstacle, a channel, etc.) in an image. For example, the space features may include an area of an object, a positioning location of an object, a shape of an object, an integral or local brightness, a location of an object, a boundary of an object, an edge of an object, an angle of an object, a ridge of an object, a spot content, or the like, or any combination thereof. In some embodiments, the analysis module 310 may determine one or more historical time features from two or more images of the plurality of images. The historical time features may include changes of certain physical properties in an image sequence including the plurality of images or the two or more images. For example, the historical time features may include a time mode, a movement, a time gradient, or the like, or any combination thereof. For example, the analysis module 310 may determine a movement based on a time-series analysis of historical features. The time-series analysis of the historical features may include analyzing the images within a particular time period. Image analysis over time may reveal movement patterns in a plurality of still images captured over time. The movement may include a translation of an object, a rotation of an object, or the like. The movement patterns may indicate seasonality or periodicity that occurs again. In some embodiments, a moving average or a regression analysis may be used. In addition, certain types of filters (e.g., a morphological filter, a Gaussian filter, an unsharp filter, a frequency filter, an averaging filter, a median filter, etc.) may be used in the analysis on image data to reduce errors. The analysis may be implemented in a time domain or in a frequency domain.

In some embodiments, the analysis module 310 may process the images using a particular technique to determine one or more features as one or more orthogonal inputs. In some embodiments, the particular technique may include a principal component analysis (PCA), an independent component analysis, an orthogonal decomposition, a singular value decomposition, a whitening technique or a spheroidizing technique, or the like. The orthogonal inputs may be linearly independent.

In 1504, the analysis module 310 may determine the first frame as a reference frame and the second frame as a candidate frame. In some embodiments, the analysis module 310 may select the reference frame and the candidate frame using a model. In some embodiments, the model may include a technique, an algorithm, a procedure, an equation, a rule, or the like, or any combination thereof. Mere by way of example, the model may include an image segmentation model, an image enhancement model, a user interface model, a workflow model, or the like, or any combination thereof. In some embodiments, the model may include models of big data and artificial intelligence, e.g., a Feedforward Neural Networks (FNN), a Recurrent Neural Network (RNN), a Kohonen self-organizing map, an automatic encoder, a Probabilistic Neural Network (PNN), a Time Delay Neural Network (TDNN), a Radial Basis Function Network (RBF), a Learning Vector Quantization, a Convolutional Neural Network (CNN), an Adaptive Linear Neuron (ADALINE) Model, an Associated Neural Network (ASNN), a Generative Adversary Networks (GAN), or the like, or any combination thereof. Exemplary recurrent neural network (RNN) may include a Hopfield network, a Boltzmann machine, an echo state network, a long-term short-term memory network, a two-way recurrent neural network, a hierarchical recurrent neural network, a random neural network, or the like or any combination thereof.

In 1506, the analysis module 310 may determine one or more first pixels in the reference frame corresponding to one or more second pixels in the candidate frame. In some embodiments, the reference frame and the candidate frame may have an overlapping region. At this time, the one or more first pixels and the one or more second pixels may indicate the same positions of an object in the overlapping region of the reference frame and the candidate frame. In some embodiments, the one or more first pixels may be a set of pixels Ω described in FIG. 4. In some embodiments, the reference frame and the candidate frame may not have an overlapping region. That is, any region in the reference frame may not correspond to any region in the candidate frame. At this time, pixels in the reference frame and pixels in the candidate frame may be not selected as the one or more first pixels and/or the one or more second pixels.

In some embodiments, the analysis module 310 may determine the one or more second pixels in the candidate frame, and/or the one or more first pixels in the reference frame using a clustering algorithm. The clustering algorithm may include a hierarchical clustering algorithm, a subarea clustering algorithm, a density clustering algorithm, a model clustering algorithm, a grid clustering algorithm, and a soft computing clustering algorithm. The hierarchical clustering algorithm may include an aggregate hierarchical clustering and a segmentation hierarchical clustering, a single-link clustering, a full-link clustering, an average link clustering, or the like. The subarea clustering algorithm may include a minimum error algorithm (e.g., a K-means algorithm, a K-center technique, a K-prototype algorithm), a graphical theory clustering, or the like. The density clustering algorithm may include an expectation maximization algorithm, a Density-based Spatial Clustering of Applications with Noise (DBSCAN) algorithm, a an Ordering Points To Identify the Clustering Structure (OPTICS) algorithm, an automatic clustering algorithm, a Selection of Negatives through Observed Bias (SNOB) algorithm, an MCLUST algorithm, or the like. The model clustering algorithm may include a decision tree clustering, a neural network clustering, a self-organizing map clustering, or the like. The soft computing clustering algorithm may include a fuzzy clustering, an evolutionary techniques for clustering, a simulated annealing algorithm for clustering, or the like.

In 1508, the analysis module 310 may determine depth information, intensity information and/or displacement information of the reference frame and the candidate frame. In some embodiments, the process for determining the depth information, the intensity information, and/or the displacement information may be found in FIG. 4 and the description thereof.

In 1510, the analysis module 310 may determine whether the candidate frame is the last frame. Specifically, the analysis module 310 may detect whether a subsequent frame of the candidate frame exists in the time domain. If the subsequent frame of the candidate frame exists, the process may proceed to operation 1512; otherwise, the process may proceed to operation 1514.

In 1512, the analysis module 310 may output the reference frame and depth information and/or displacement information corresponding to the reference frame if the candidate frame is the last frame.

In 1514, the analysis module 310 may determine a difference between the reference frame and the candidate frame. In some embodiments, the difference between the reference frame and the candidate frame may be determined based on the intensity information of the reference frame and the intensity information of the candidate frame. In some embodiments, the intensity information of the reference frame may be determined by RGB intensities of the one or more first pixels, and the intensity of the candidate frame may be determined by RGB intensities of the one or more second pixels. In some embodiments, the intensity information of the reference frame and the intensity information of the candidate frame may be determined in 1504. In some embodiments, the intensity information of the reference frame and the intensity information of the candidate frame may be determined in 1514 before determining the difference between the reference frame and the candidate frame.

In 1516, the analysis module 310 may determine whether the difference between the reference frame and the candidate frame is greater than a threshold. If the difference between the reference frame and the candidate frame is greater than the threshold, the process may proceed to operation 1518; otherwise, the process may proceed to operation 1520.

In 1518, if the difference between the reference frame and the candidate frame is greater than the threshold, the analysis module 310 may designate the candidate frame as an updated reference frame and designate a frame subsequent with the candidate frame as an updated candidate frame. In some embodiments, the frame subsequent with the candidate frame may be a frame that is closely adjacent to the candidate frame. At this time, the updated reference frame and the updated candidate frame may be transmitted to operation 1506 to repeat the process 1500.

In 1520, if the difference between the reference frame and the candidate frame is smaller than or equal to the threshold, the analysis module 310 may designate a frame subsequent with the candidate frame as an updated candidate frame. At this time, the updated reference frame and the updated candidate frame may be transmitted to step 1506 to repeat the process 1500.

In some embodiments, operation 1518 or operation 1520 may output the updated reference frame and the updated candidate frame to be processed by the analysis module 310. In some embodiments, the updated reference frame may be obtained by replacing the reference frame with the candidate frame when the difference between the reference frame and the candidate frame is greater than the threshold. In some embodiments, the updated candidate frame may be obtained by replacing the candidate frame by the subsequent frame. That is, the replacement of the candidate frame may be unconditional, and the replacement of the reference frame may be conditional.

The process 1500 may be terminated when the map is generated in operation 1512. In some embodiments, some termination conditions may be designated so that the process 1500 may be terminated in time. For example, a counter may be used in the process 1500 so that the count of cycles of the process 1500 may be smaller than or equal to a predetermined threshold value.

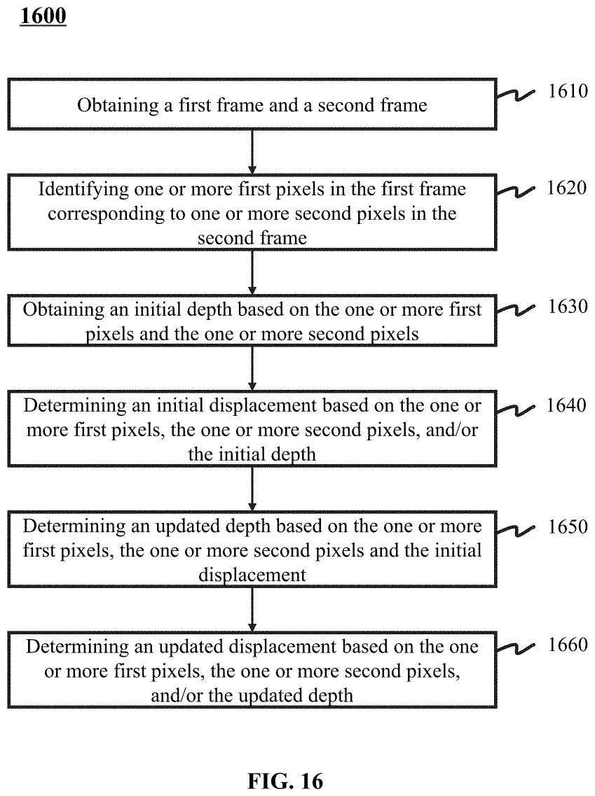

FIG. 16 is a flowchart illustrating an exemplary process for obtaining depth information and displacement information of a reference frame and/or depth information and displacement information of a candidate frame according to some embodiments of the present disclosure. In some embodiments, the process may be implemented by the analysis module 310. In some embodiments, the process is similar to the process for obtaining the displacement and depth of the frame as described in FIG. 4.

In 1610, the analysis module 310 may obtain a first frame and a second frame from the plurality of frames obtained by the image sensor 810. In some embodiments, the analysis module 310 may select the first frame and the second frame from the plurality of frames obtained by image sensors. In some embodiments, the first frame and the second frame may be adjacent to each other with respect to the time domain. The first frame may be an existing frame and the second frame may be a subsequent frame.

In 1620, the analysis module 310 may identify one or more first pixels in the first frame corresponding to one or more second pixels in the second frame. The identifying the one or more first pixels in the first frame corresponding to one or more second pixels may be implemented using the process described in operation 1506 as illustrated in FIG. 15.

In 1630, the analysis module 310 may obtain an initial depth based on the one or more first pixels and the one or more second pixels. In some embodiments, the initial depth may be set as a zero matrix. In 1640, the analysis module 310 may determine an initial displacement based on the one or more first pixels, the one or more second pixels and/or the initial depth. For example, operation 1640 may be implemented using Equation (1) as described in FIG. 4.

In 1650, the analysis module 310 may determine an updated depth based on the one or more first pixels, the one or more second pixels and the initial displacement. In some embodiments, operation 1650 may be implemented using Equation (2) as described for FIG. 4. In some embodiments, the analysis module 130 may obtain the updated depth by solving Equation (2) using an optimization algorithm. For example, the optimization algorithm may include a random search, a Newton algorithm, a quasi-Newton algorithm, an evolution algorithm, a coordinate descent algorithm, a proximal gradient algorithm, a gradient descent algorithm, a steepest descent algorithm, a conjugate gradient algorithm, a double conjugate gradient algorithm, or the like.

In 1660, the analysis module 310 may determine an updated displacement based on the one or more first pixels, the one or more second pixels, and/or the updated depth. In some embodiments, operation 1660 may be implemented using Equation (1) as described for FIG. 4. That is, the updated depth is replaced with the initial depth.

As illustrated in FIG. 4, the initial displacement may be obtained using Equation (1). As shown in Equation (1), an initial value of the displacement may be needed for determining the initial displacement. FIG. 17A is a flowchart illustrating an exemplary process for determining the initial value of displacement according to some embodiments of the present disclosure. This process may be implemented by the analysis module 310 based on the image data obtained by the image sensor 810.

In 1710, the image data may be obtained by the analysis module 310. In some embodiments, the initial value of displacement may be determined based on the image data. More specifically, the initial value of displacement may be determined based on displacements in the image data. In some embodiments, the displacements in the image data may include a displacement of a movement unit (e.g., two wheels) and a displacement of a camera relative to the movement unit within a time interval when two adjacent frames are obtained.

In 1720, the analysis module 310 may obtain a first displacement associated with the movement unit based on the image data. In some embodiments, the first displacement associated with the movement unit may include a displacement of a central point of the two wheels within the time interval. In some embodiments, the first displacement associated with the movement unit may include a displacement of a point where a navigation sensor is located within the time interval. In some embodiments, the navigation sensor may be installed in the central point of the two wheels. In some embodiments, the time interval may be the time interval within which the image sensor 810 obtains the two adjacent frames.

In 1730, the analysis module 310 may obtain a second displacement associated with the image sensor 810 with respect to the movement unit. In some embodiments, the second displacement may include a displacement of the image sensor 810 relative to the movement unit. In some embodiments, the image sensor 810 may include a camera.

In 1740, the analysis module 310 may determine a third displacement associated with the image sensor 810 based on the first displacement and the second displacement. In some embodiments, the third displacement may be a vector sum of the first displacement and the second displacement. In some embodiments, the third displacement may be the initial value of displacement for determining the initial displacement value.

During the movement of the intelligent robot 110, a holder may need to be controlled to obtain a precise attitude of the intelligent robot 110. In some embodiments, the attitude of the intelligent robot 110 may be controlled by controlling a rotary angle of an axis of the holder 930. FIG. 17B is a flowchart illustrating an exemplary process for determining an attitude of the intelligent robot 110 according to some embodiments of the present disclosure. The process may be implemented by the analysis module 310 based on the rotary angle of the axis of the holder 930.

In 1715, the image data may be obtained by the analysis module 310. As described in FIG. 17A, the image data may include frames, displacements and an initial depth. In some embodiments, the image data may also include rotary information.

In 1725, the analysis module 310 may obtain a first rotary angle with respect to a reference axis. The first rotary angle may be associated with the movement unit based on the image data. In some embodiments, the first rotary angle with respect to the reference axis associated with the movement unit may be obtained based on rotary information from the image data. In some embodiments, the first rotary angle may include an angle within the time interval. In some embodiments, the time interval may include a time interval at which the image sensor 810 obtains the two frames.

In 1735, the analysis module 310 may obtain a second rotary angle with respect to the movement unit associated with the image sensor within the time interval. In some embodiments, the second rotary angle may include a relative rotary angle of the image sensor 810 relative to the movement unit. In some embodiments, the image sensor 810 may include a camera.

In 1745, the analysis module 310 may determine a third rotary angle with respect to a reference axis associated with the image sensor 810. In some embodiments, the third rotary angle may be determined based on the first rotary angle and the second rotary angle. In some embodiments, the third angle may be a vector sum of the first rotary angle and the second rotary angle.

During the movement of the intelligent robot 110, the sensor(s) 230 may be installed in the movement module 920 and the holder 930 to obtain information. In some embodiments, the sensor(s) 230 may be installed in the carrier 1010, or the sensor(s) 230 may be installed in an intelligent phone held by the holder 930. In some embodiments, the movement module 920 and the holder 930 may need all-directional stabilization to obtain precise and reliable information. The process for keeping the balance of the movement module 920 and the holder 930 relative to horizontal plane may be described in detail in the description of FIG. 18.

FIG. 18 is a block diagram of a gyroscope and an accelerometer determining an angle between a horizontal plane and the Z axis according to some embodiments of the present disclosure. In some embodiments, the horizontal plane may be a carrying plane of the carrier 1010. The angle between the horizontal plane and the Z axis may be determined based on gyroscope data and accelerometer data. In some embodiments, the horizontal plane may be a relative plane of the holder 930 to detect a pitch angle of the holder 930.

As shown in FIG. 18, the system may include an adder 1810, an integrator 1820, a component extractor 1830 and an adder 1840. The adder 1810, the integrator 1820, the component extractor 1830 and the adder 1840 may constitute a feedback loop for determining an output angle. An angle between the horizontal plane and the Z axis of each frame obtained by the image sensor 810 may be obtained by the integrator 1820. Assuming that a first frame is obtained by the image sensor 810 at time t₁, and a second frame is obtained by the image sensor 810 at time t₂, The gyroscope 830 and the accelerometer 820 may obtain angular velocities and angle information at times t₁ and t₂. In some embodiments, an output angle θ₂ associated with the second frame obtained at time t₂ may be determined based on an output angle θ₁ associated with the first frame obtained at time t₁, gyroscope data and accelerometer data obtained at time t₂.

Firstly, the gyroscope data and the accelerometer data of the first frame may be processed at time t₁. The integrator 1820 may generate the output angle θ₁ associated with the first frame. The accelerometer 820 may generate a first angle θ₁′. The adder 1840 may generate a second angle θ₁″ based on the output angle θ₁ and the first angle θ₁′. In some embodiments, the second angle θ₁″ may be obtained by vector subtracting the output angle θ₁ from the first angle θ₁′. A compensatory angular velocity ω₁″ may be determined by the component extractor 1830 based on the second angle θ₁″. In some embodiments, the component extractor 1830 may include a differentiator.

Then, the gyroscope data and the accelerometer data of the second frame may be processed at time t₂. The gyroscope 830 may generate an angular velocity ω₂. The adder 1810 may generate a revised angular velocity ω₂′ based on the angular velocity ω₂ and the compensatory angular velocity ω₁″. In some embodiments, the revised angular velocity ω₂′ may be obtained as a vector sum of the angular velocity ω₂ and the compensatory angular velocity ω₁″. Finally, the integrator 1820 may output the angle θ₂ associated with the second frame at time t₂ based on the revised angular velocity ω₂′.

In some embodiments, the process described in FIG. 18 may be implemented by the processor 210. For example, the gyroscope data and the accelerometer data may be transmitted to the processor 210 (e.g., a portion of an intelligent phone) through an API interface. For each frame, the processor 210 may determine an output angle at a time when the frame is captured. In some embodiments, the angle between the horizontal plane and the Z axis may be detected at each time of capturing each frame. The balance of the system on the horizontal plane may be maintained based on the real-time output angle associated with each frame.

FIG. 19 is a flowchart illustrating an exemplary process 1900 for determining an angle associated with a frame. The process 1900 may be implemented by the processor 210.

In 1910, the processor 210 may obtain a plurality of frames including a first frame and a second frame. In some embodiments, the first frame and the second frame may be captured by the image sensor 810 within a time interval. For example, the first frame may be captured by the image sensor 810 at time t₁. The second frame may be captured by the image sensor 810 at time t₂. A time interval between t₁ and t₂ may be a sampling interval of the image sensor 810.

In 1920, the processor 210 may obtain gyroscope data and accelerometer data associated with the first frame and/or the second frame. In some embodiments, the gyroscope data and the accelerometer data may include parameters such as angular velocities and angles.

In 1930, the processor 210 may determine first angular information based on the accelerometer data associated with the first frame. In some embodiments, the first angular information may include a first angle.

In 1940, the processor 210 may determine compensatory angular information based on the first angular information and angular information associated with the first frame. In some embodiments, the angular information associated with the first frame may be an output angle associated with the first frame. In some embodiments, the first angular information may be processed by vector subtracting the output angle associated with the first frame. In some embodiments, the compensatory angular information may include a compensatory angular velocity. The compensatory angular velocity may be determined by the component extractor 1830 based on the subtraction of the output angle associated with the first frame from the first angular data.

In 1950, the processor 210 may determine second angular information based on the compensatory angular information and the gyroscope data associated with the second frame. In some embodiments, the second angular data may include an angle between the horizontal plane and the Z axis detected by the processor 210 associated with the second frame at time t₂ when the second frame is captured.

As illustrated in FIG. 18 and FIG. 19, the output angle associated with the second frame may be fed back to the output angle associated with the first frame. With this cycle process and the gyroscope data as well as the accelerometer data, an output angle for each frame may be obtained by the processor 210. In some embodiments, the angle between the horizontal plane and the Z axis may exceed a threshold, then a control signal for keeping balance may be generated.

The process for keeping horizontal balance of the movement module 920 or the holder 930 may be illustrated in FIG. 18 and FIG. 19. During a movement of the intelligent robot 110, sensors installed in an intelligent phone held by the holder 930 may obtain information. In some embodiments, the information may include image data, gyroscope data, accelerometer data and data obtained by other sensors. Horizontal balance needs to be kept by the processor 210 to make the second type sensors 1240 in the intelligent phone obtain information stably. On the other hand, a road may be not plain for the second type sensors 1240 in the intelligent phone held by the holder 930 to obtain the information stably. In some embodiments, balance of the vertical axis may also be necessary for sensors in the intelligent phone to obtain the stable information.

FIG. 20 is a flowchart illustrating an exemplary process 2000 for adjusting vertical displacement of the second type sensors 1240 in an intelligent phone. In some embodiments, the process may be implemented by the processor 210 by controlling the dynamic Z-buffering rod 1120 shown in FIG. 11 based on the control parameters generated by the intelligent robot control module 330.

In 2010, the processor 210 may obtain a first displacement of a motor along a rotation axis. In some embodiments, the rotation axis may include Z axis, and the first displacement may be a vector along the Z axis.

In 2020, the processor 210 may determine whether the displacement of the motor along the Z axis is greater than a threshold. In some embodiments, the threshold may be a limit value within which the second type sensors 1240 can obtain information stably.

In 2030, the processor 210 may generate a first control signal to cause the motor to move to an initial position when the displacement of the motor is greater than the threshold. In some embodiments, the initial position may be a position predetermined and suitable for obtaining the information.

In 2040, the processor 210 may output the first control signal to the motor to make the second type sensors 1240 installed in the intelligent phone back to the initial position to obtain stable information.

In 2050, the processor 210 may obtain a first acceleration along the rotation axis when the displacement of the motor is smaller than or equal to the threshold. In some embodiments, the acceleration may be obtained by the accelerometer 820 installed in the intelligent phone.

In 2060, the processor 210 may generate a second acceleration based on the first acceleration. In some embodiments, the second acceleration may be a filtered acceleration of the first acceleration.

In 2070, the processor 210 may determine a second displacement based on the second acceleration. In some embodiments, the second displacement may be calculated based on an integral value of the second acceleration. In some embodiments, the second displacement may be a vector along with Z axis.

In 2080, the processor 210 may generate a second control signal to control a movement of the motor based on the second displacement. In some embodiments, the second control signal may determine a remaining gap (a remaining range available for the movement) of displacement based on the second displacement and the threshold. Then the processor 210 may control the movement of the sensors in the intelligent phone along with the Z axis.

In 2090, the processor 210 may output the second control signal to the motor.

The present disclosure is described and illustrated with reference to a plurality of embodiments, it will be understood by those skilled in the art that various changes in form and details may include made therein without departing from the spirit and scope of the present disclosure, as defined by the appended claims and their equivalents.

1. An intelligent wheelchair system, comprising:
a movement module including a wheel, a carrier, and a first type sensor;
a holder including a second type sensor; and
a processor including an analysis module, a navigation module, and a control module, wherein the processor is configured to:
establish communication with the holder and the movement module respectively;
obtain information from the second type sensor and the first type sensor respectively;
determine a destination and a location of the intelligent wheelchair system;
construct a map according to the information;
plan a route for the intelligent wheelchair system according to the map;
determine control parameters for the intelligent wheelchair system according to the route, the information and an artificial intelligence technique; and
control a movement and an attitude of the intelligent wheelchair system according to the control parameters.

2. The intelligent wheelchair system of claim 1, wherein the processor communicates with the holder and the movement module respectively using an application programming interface.

3. The intelligent wheelchair system of claim 1, wherein the processor is further configured to:
obtain image data;
determine at least one reference frame including pixels according to the image data;
determine depth information and displacement information according to the at least one reference frame corresponding to the image data; and
generate a map according to the at least one reference frame, the depth information, and the displacement information.

4. The intelligent wheelchair system of claim 3, wherein the processor is further configured to:
obtain a plurality of frames at least including a first frame and a second frame;
determine the first frame as a first reference frame, and the second frame as a first candidate frame;
determine at least one first pixel in the first reference frame corresponding to at least one second pixel in the first candidate frame;
determine depth information, intensity information, and/or displacement information of the first reference frame and depth information, intensity information, and/or displacement information of the first candidate frame;
output the first reference frame, the depth information, the intensity information, and the displacement information when the first candidate frame is a last frame;
determine a difference between the first reference frame and the first candidate frame according to the intensity information of the first reference frame and the intensity information of the first candidate frame when the first candidate frame is not the last frame;
determine the first candidate frame as a second reference frame and a subsequent frame as a second candidate frame when the difference between the first reference frame and the first candidate frame is greater than a threshold;
determine the subsequent frame as a second candidate frame when the difference between the first reference frame and the first candidate frame is smaller than or equal to the threshold; and
obtain all reference frames and depth information and displacement information corresponding to the all reference frames.

5. The intelligent wheelchair system of claim 4, wherein the processor is further configured to:
obtain initial depth information according to the at least one first pixel and/or the at least one second pixel;
determine an initial displacement of an image sensor according to an initial displacement value and/or the initial depth information;
determine updated depth information according to the at least one first pixel, the at least one second pixel, and/or the initial displacement of the image sensor; and
determine an updated displacement of the image sensor according to the initial displacement value and/or the updated depth information.

6. The intelligent wheelchair system of claim 5, wherein the processor is further configured to:
obtain a first displacement associated with the wheel according to the image data;
obtain a second displacement of the image sensor associated with the wheel;
determine a third displacement of the image sensor according to the first displacement and the second displacement; and
set the third displacement as the initial displacement for determining the initial displacement value.

7. The intelligent wheelchair system of claim 4, wherein the processor is further configured to:
determine the at least one second pixel in the candidate frame and/or the at least one first pixel in the reference frame using a clustering algorithm.

8. A method for controlling an intelligent wheelchair, the intelligent wheelchair comprising at least one processor, a holder, and a movement module, and the method comprising:
establishing communication between the processor and the holder, between the processor and the movement module;
obtaining, by the processor, information of one or more sensors in the holder and the movement module respectively;
determining, by the processor, a destination and a location of the intelligent wheelchair;
obtaining, by the processor, a map according to the information;
planning, by the processor, a route from the location to the destination of the intelligent wheelchair according to the map;
determining control parameters for the movement module and the holder according to the route and the information; and
controlling a movement and an attitude of the intelligent wheelchair based on the control parameters.

9. The method of claim 8, wherein the processor communicates with the holder and the movement module respectively using an application programming interface.

10. The method of claim 8 further comprising:
obtaining image data;
determining at least one reference frame including pixels according to the image data;
determining depth information and displacement information according to the reference frame corresponding to the image data; and
constructing a map according to the at least one reference frame, the depth information, and the displacement information.

11. The method of claim 10, further comprising:
obtaining a plurality of frames at least including a first frame and a second frame;
determining the first frame as a first reference frame, and the second frame as a first candidate frame;
determining at least one first pixel in the first reference frame corresponding to at least one second pixel in the first candidate frame;
determining depth information, intensity information, and/or displacement information of the first reference frame and depth information, intensity information, and/or displacement information of the first candidate frame;
outputting the first reference frame, the depth information, the intensity information, and the displacement information when the first candidate frame is a last frame;
determining a difference between the first reference frame and the first candidate frame according to the intensity information of the first reference frame and the first candidate frame when the first candidate frame is not the last frame;
determining the first candidate frame as a second reference frame and a subsequent frame as a second candidate frame when the difference between the first reference frame and the first candidate frame is greater than a threshold;
determining the subsequent frame as a second candidate frame when the difference between the first reference frame and the first candidate frame is smaller than or equal to the threshold; and
obtaining all reference frames and depth information and displacement information corresponding to the all reference frames.

12. The method of claim 11, further comprising:
obtaining initial depth information according to the at least one first pixel and/or the at least one second pixel;
determining an initial displacement of an image sensor according to an initial displacement value and/or the initial depth information;
determining updated depth information according to the at least one first pixel, the at least one second pixel, and/or the initial displacement of the image sensor; and
determining an updated displacement of the image sensor according to the initial displacement value and/or the updated depth information.

13. The method of claim 12, further comprising:
obtaining a first displacement associated with the wheels according to the image data;
obtaining a second displacement of the image sensor associated with the wheels;
determining a third displacement of the image sensor according to the first displacement and the second displacement; and
setting the third displacement as the initial displacement for determining the initial displacement value.

14. The method of claim 11 further comprising:
determining, by the processor, at least one second pixel in the candidate frame and/or at least one first pixel in the reference frame using a clustering algorithm.
